(19) United States
(12) Patent Application Publication
(10) Pub. No.: US 2026/0297420 A1
(43) Pub. Date: Oct. 1, 2026

(54) SURFACE ACTIVE ORGANIC ALKALI AGENTS

(71) Applicant: ULTIMATE EOR SERVICES LLC, Austin, TX (US)

(72) Inventors: Upali Peter WEERASOORIYA, Austin, TX (US); Karasinghe Arachchige Nadeeka UPAMALI, Austin, TX (US); Nina LOAHARDJO, Austin, TX (US); Christopher James BRITTON, Austin, TX (US); Robert Matthew DEAN, Austin, TX (US)

(21) Appl. No.: 19/476,948

(22) PCT Filed: Apr. 22, 2024
(86) PCT No.: PCT/US2024/025674

§ 371 Date: Oct. 20, 2025

Related U.S. Application Data
(60) Provisional application No. 63/497,279, filed on Apr. 20, 2023.

(51) Int. Cl. C09K 8/584; C07F 9/46; C08G 65/26; E21B 43/16

(52) U.S. Cl. CPC C09K 8/584; C07F 9/46; C08G 65/2624; E21B 43/16

(57) ABSTRACT

Described herein are compounds as well as methods of using thereof in oil and gas operations.

### CROSS-REFERENCE TO RELATED APPLICATIONS

This application claims benefit of priority of U.S. Provisional Application No. 63/497,279, filed Apr. 20, 2023, which is hereby incorporated herein by reference in its entirety.

### BACKGROUND

Enhanced Oil Recovery (EOR) refers to techniques for increasing the amount of unrefined petroleum, or crude oil that may be extracted from an oil reservoir (e.g., an oil field). Using EOR, 40-60% of the reservoir's original oil can typically be extracted compared with only 20-40% using primary and secondary recovery (e.g., by water injection or natural gas injection). Enhanced oil recovery may also be referred to as improved oil recovery or tertiary oil recovery (as opposed to primary and secondary oil recovery).

Enhanced oil recovery may be achieved by a variety of methods including miscible gas injection (which includes carbon dioxide flooding), chemical injection (which includes polymer flooding, alkaline flooding, and surfactant flooding), microbial injection, or thermal recovery (which includes cyclic steam, steam flooding, and fire flooding). The injection of various chemicals, usually as dilute aqueous solutions, has been used to improve oil recovery. Injection of alkaline or caustic solutions into reservoirs with oil that has organic acids naturally occurring in the oil (also referred to herein as “unrefined petroleum acids”) will result in the production of soap that may lower the interfacial tension enough to increase production. Injection of a dilute solution of a water soluble polymer to increase the viscosity of the injected water can increase the amount of oil recovered from geological formations. Aqueous solutions of surfactants such as petroleum sulfonates may be injected to lower the interfacial tension or capillary pressure that impedes oil droplets from moving through a reservoir. Special formulations of oil, water and surfactant microemulsions have also proven useful. Such formulations often include co-solvent compounds to increase the solubility of the solutes in the presence of oil and decrease the viscosity of an emulsion.

There is a need in the art for cost effective methods for enhanced oil recovery using chemical injection. Provided herein are methods and compositions addressing these and other needs in the art.

### SUMMARY

Described herein are compounds defined by Formula I below

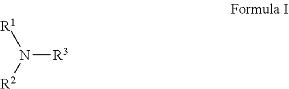

wherein R³ is a C₁-C₆ alkyl or C₃-C₆ cycloalkyl,

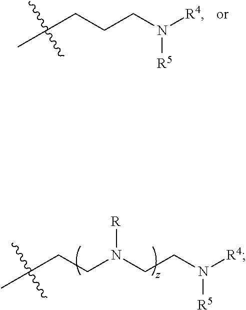

R¹, R², R⁴, R⁵ and R are, independently for each occurrence, hydrogen, C₁-C₆ alkyl or C₃-C₆ cycloalkyl, —(PO)ₓ, or —(PO)ₓ(EO)_{y}, wherein at least one of R¹, R², R⁴, R⁵, or R is —(PO)ₓH, or —(PO)ₓ(EO)_{y}H; x is an integer from 1 to 10; y is an integer from 0-30; and z is an integer from 0 to 10.

In certain embodiments, the compound can be selected from:

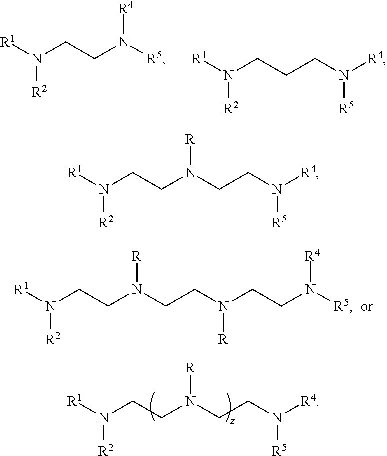

where R, R¹, R², R⁴, R⁵, and z are as defined above with respect to Formula I.

Also described herein are aqueous compositions including water and the compounds described herein.

Also described herein are emulsions including the composition described herein or the compounds described herein and (ii) unrefined petroleum.

Also described herein are methods of displacing an unrefined petroleum material in contact with a solid material, said method including: (i) contacting the unrefined petroleum material with the compounds described herein or the compositions described here, wherein the unrefined petroleum material is in contact with the solid material; and (ii) allowing the unrefined petroleum material to separate from the solid material, thereby displacing the unrefined petroleum material in contact with the solid material.

Described hereina are also methods for recovering hydrocarbons from a subterranean formation, the method including: (a) introducing the compounds described herein or the composition described herein through a wellbore into the subterranean formation; and (b) producing fluids from the subterranean formation. In some embodiments, wherein the hydrocarbons in the subterranean formation include live oil.

### BRIEF DESCRIPTION OF THE FIGURES

FIG. 1 is a plot comparing the surface tension of varying amines (monoethanolamine (MEA), diethanolamine (DEA), triethanolamine (TEA), dimethylaminopropylamine (DMAPA), and DMAPA-2PO) at varying concentrations. DMAPA exhibits a lower surface tension that MEA, DEA, and TEA. The introduction of PO groups in DMAPA (as in the case of DMAPA) considerably lowers the surface tension.

FIG. 2 shows the pH of aqueous solutions containing various concentrations of MEA, Na₂CO₃, and DMAPA.

FIG. 3 is a plot of an alkalinity titration performed using MEA, Na₂CO₃, and DMAPA. At any given concentration, DMAPA provides a higher pH than MEA or Na₂CO₃. At any given concentration, DMAPA produced a higher number of moles of soap than MEA or Na₂CO₃.

FIG. 4 is a plot of an alkalinity titration performed using MEA, Na₂CO₃, and DMAPA. As shown in FIG. 4, DMAPA produced a higher number of moles of soap than MEA or Na₂CO₃. This allows one to use a lower concentration of DMAPA and/or a higher pH to generate an ammonium salt of naphthenic acid in crude oil. For example, 0.6% by weight DMAPA can produce the same number of moles of soap as 1% MEA.

FIG. 5 summarizes example formulations containing MEA, DMAPA, and DMAPA-2PO in both alkali-surfactant-polymer (ASP) and alkali-cosolvent-polymer (ACP) modes.

FIG. 6 summarizes the results of an initial investigation of an example ASP formulation containing 1% by weight MEA and 0.5% by weight surfactant (alkoxy carboxylate and ABS). Phase behavior studies showed that the composition exhibits ultra-low IFT with 10%, 30%, and 50% oil. The compositions also exhibited aqueous stability (they were clear and transparent until ~15K ppm TDS with polymer. Samples were slightly hazy until ~19K ppm TDA without polymer. No phase separation was observed.

FIG. 7 shows phase behavior plots (left, 30% and 50% oil) and an activity map (right) obtained using an example ASP formulation containing 1% by weight MEA and 0.5% by weight surfactant (alkoxy carboxylate and ABS). Aqueous stability was approximately 35K ppm TDS with polymer.

FIG. 8 summarizes the results of an initial investigation of an example ASP formulation containing 1% by weight DMAPA, 0.3% by weight C28-45PO-10EO-carboxylate, 0.2% by weight H117, and NaCl at 72° C.

FIG. 9 shows phase behavior plots (left, 30% and 10% oil) and an activity map (right) obtained using an example ASP formulation containing 1% by weight DMAPA, 0.3% by weight C28-45PO-10EO-carboxylate, 0.2% by weight H117, and NaCl. Aqueous stability was approximately 17K ppm TDS with polymer.

FIG. 10 summarizes the results of an initial investigation of an example ASP formulation containing 0.6% by weight DMAPA, 0.3% by weight C28-45PO-10EO-carboxylate, 0.2% by weight H117, and NaCl at 72° C.

FIG. 11 shows phase behavior plots (left, 30% and 10% oil) and an activity map (right) obtained using an example ASP formulation containing 0.6% by weight DMAPA, 0.3% by weight C28-45PO-10EO-carboxylate, 0.2% by weight H117, and NaCl. Aqueous stability was approximately 17K ppm TDS with polymer.

FIG. 12 summarizes the results of an initial investigation of an example ASP formulation containing 0.6% by weight DMAPA-2PO, 0.5% by weight surfactant, and NaCl at 72° C.

FIG. 13 shows an activity map obtained using an example ACP formulation containing 1.0% by weight MEA and 0.5% by weight glycerine-30PO-35EO at 21° C. At a concentration of oil of 10% by weight, a low to ultralow IFT Type III microemulsion was observed at 23-25K ppm TDS. At a concentration of oil of 30% by weight, a low to ultralow IFT Type III microemulsion was observed at 21-23K ppm TDS. At a concentration of oil of 50% by weight, a low to ultralow IFT Type III microemulsion was observed at 16-18K ppm TDS. Type I shows low to ultralow IFT with mixing.

FIG. 14 shows an activity map obtained using an example ACP formulation containing 0.5% by weight DMAPA and 0.5% by weight glycerine-30PO-35EO at 21° C. At a concentration of oil of 10% by weight, a low to ultralow IFT Type III microemulsion was observed at 17-20K ppm TDS. At a concentration of oil of 30% by weight, a low to ultralow IFT Type III microemulsion was observed at 15-18K ppm TDS. At a concentration of oil of 50% by weight, a low to ultralow IFT Type III microemulsion was observed at 5-8K ppm TDS. Type I shows low to ultralow IFT with mixing.

FIG. 15 shows an activity map obtained using an example ACP formulation containing 0.5% by weight DMAPA-2PO and 0.5% by weight glycerine-30PO-35EO at 21° C. At a concentrations of oil of 10% by weight, 30% by weight, and 50% by weight, all formulations exhibits the same optimum salinity with ultralow IFT and a relatively flat activity map.

FIG. 16 summarizes the results of an initial investigation of an example ACP formulation containing 0.5% by weight DMAPA-2PO, 0.5% by weight glycerine-30PO-35EO-OH, and NaCl.

FIG. 17 is an activity map obtained using 0.5% by weight DMAPA-2PO at 21° C.

FIG. 18 is a plot showing the long term equilibration of DMAPA with argillaceous sandstone. The long term equilibrium was determined to be approximately 0.5 mg DMAPA/g of rock. These results suggest that DMAPA should exhibit long term stability and robustness at reservoir conditions.

FIG. 19 shows an evaluation of DMAPA transport in argillaceous sandstone. These results suggest DMAPA propagates well under reservoir conditions.

FIG. 20 is a comparison plot showing the pH (adjusted by alkali solution) versus soap generated (mmol/kg crude) for organic alkali agents (MEA and DEA) as well as sodium carbonate. The presence of waxy oil can complicate such titrations. Accordingly, an alternative method was used to determine the quantity of soap generated with waxy oil in which soap was extracted into the aqueous phase and quantified using a two-phase hyamine titration.

FIG. 21 illustrates soap extraction with a hydrophilic co-solvent. Samples were prepared including varying concentrations of alkali agent (sodium carbonate or MEA) from 0% by weight to 1.6% by weight with added isopropyl alcohol. Samples were equilibrated for more than two weeks before the aqueous phases were extracted for the titration. A two-phase hyamine titration was then performed using bromocresol green as an indicator and a high pH buffer. Total soap concentration was then calculated from the end point of the titration.

FIG. 22 shows the results of an alkalinity titration performed using MEA and Na₂CO₃. As shown in FIG. 22, waxy oil starts to produce soap above a pH of approximately 10. Maximum quantities of soap were produced with a pH of 10.9 and above. Based on these experiments, 1% MEA was recommended for further phase behavior experiments.

FIG. 23 summarizes an investigation of the performance of a slug containing 1% by weight MEA in SAIS-IB with 15K ppm TDS when diluted with an example water flood (SAIS-IB with 8,073 ppm TDS). The experiment demonstrated low IFT with mixing when diluting the slug with the example water flood.

FIG. 24 summarizes an investigation of the performance of a slug containing 0.6% by weight DMAPA in SAIS-IB with 17K ppm TDS when diluted with an example water flood (SAIS-IB with 8,073 ppm TDS). Dilution with 0.6% by weight DMAPA in slug shows a more favorable dilution than 1% by weight MEA due to the higher pH. Up to 54%, the slug shows low to ultralow IFT, and low ITF below 50%.

FIG. 25 summarizes the results of the investigations described herein and the characteristics of Na₂CO₃, MEA, DEA, and DMAPA.

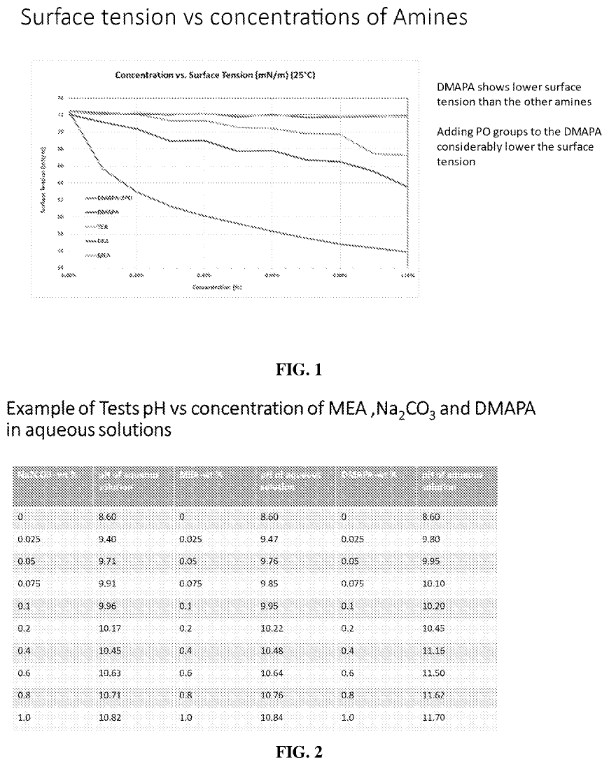

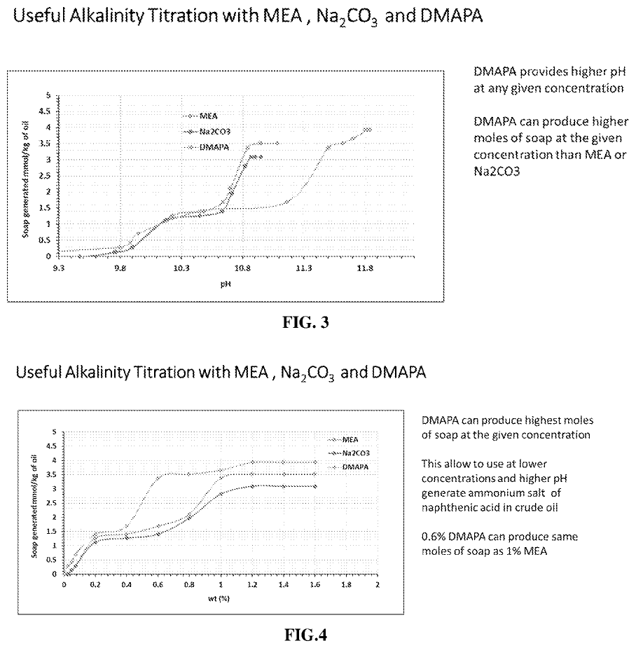

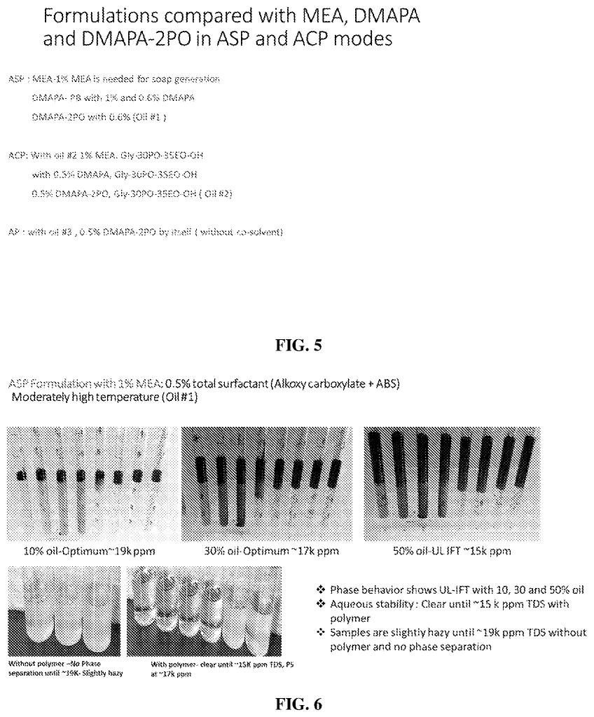

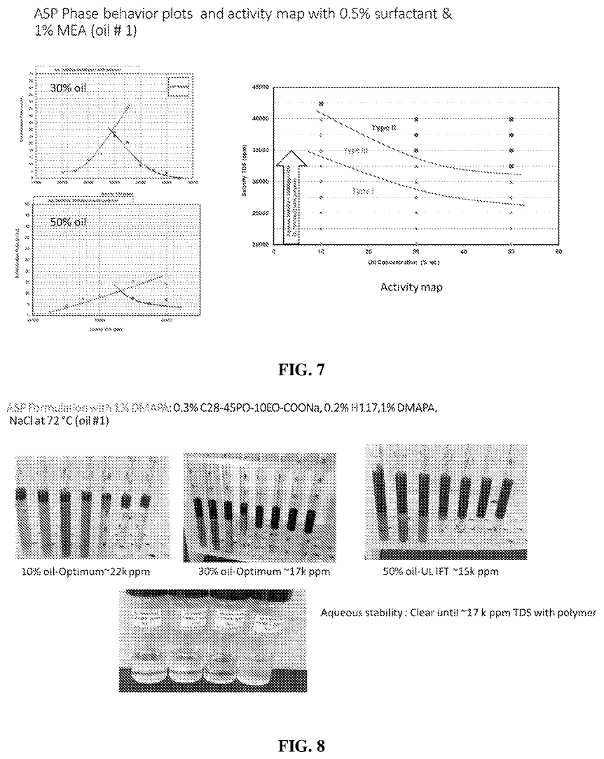

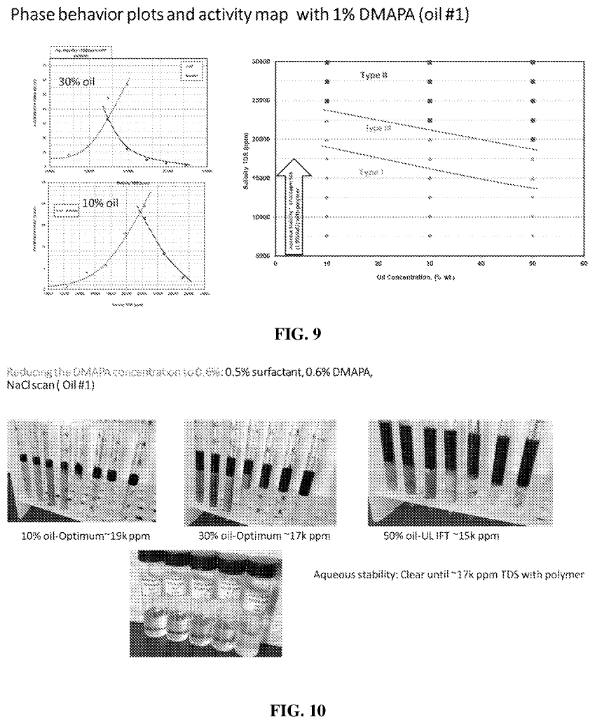

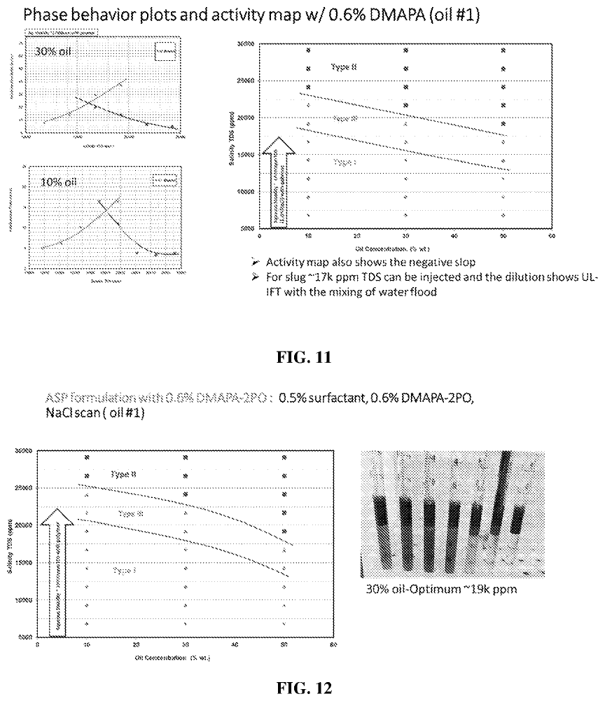

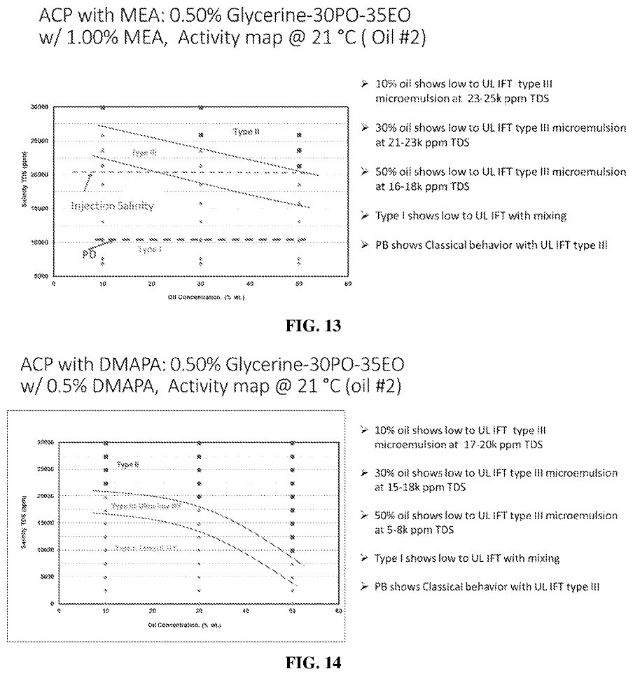

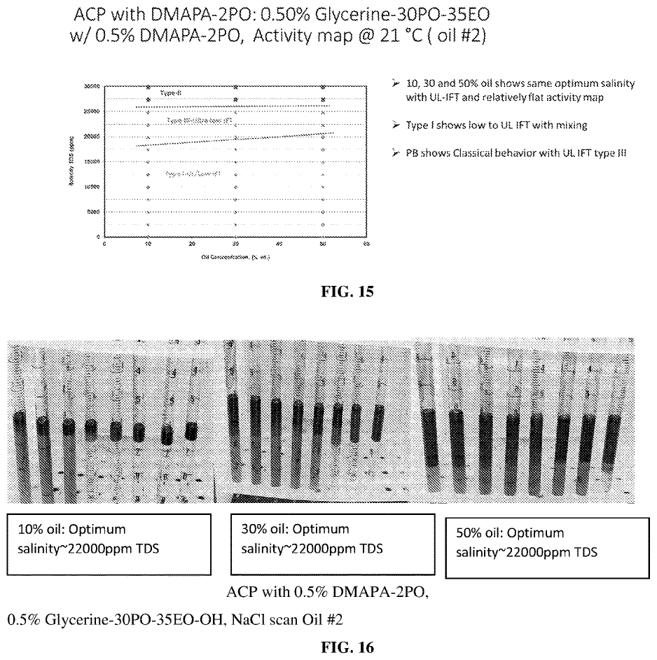

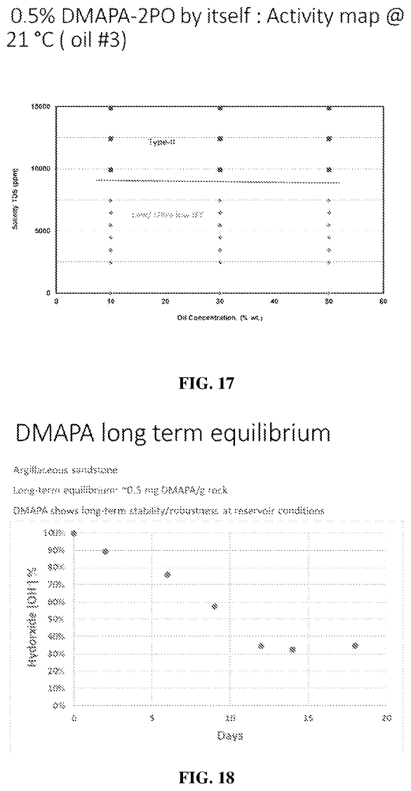

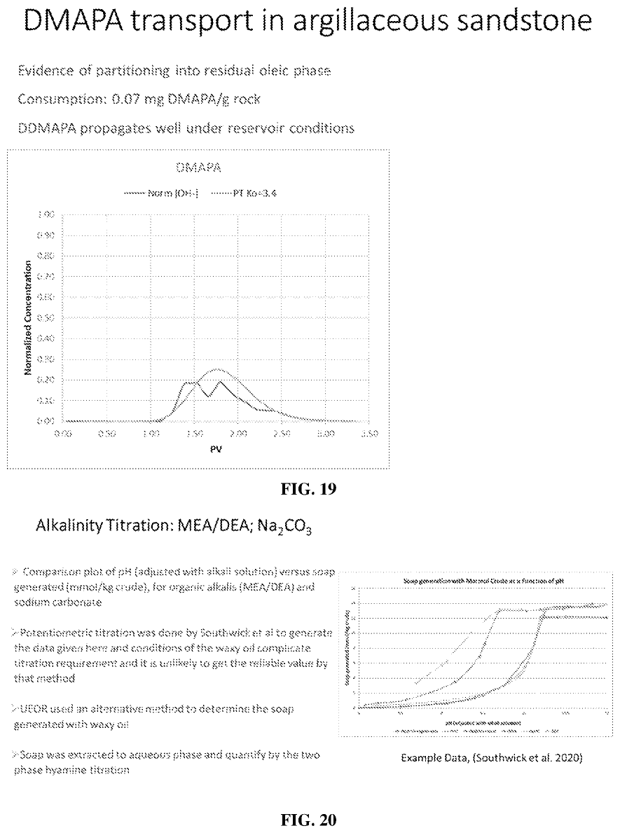

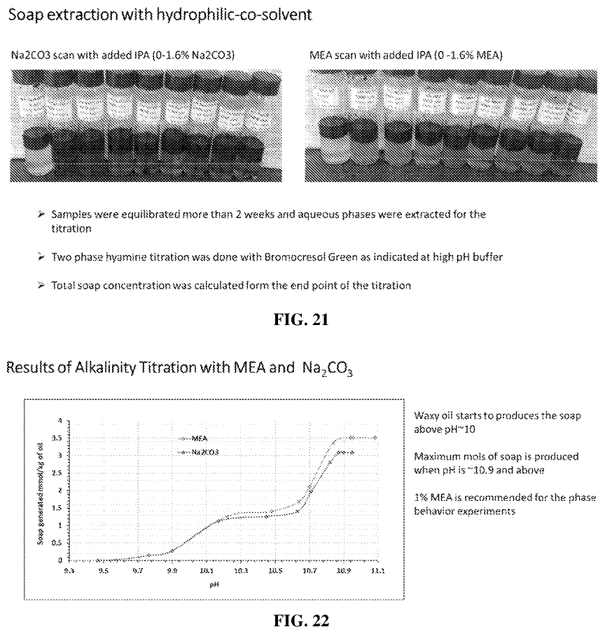

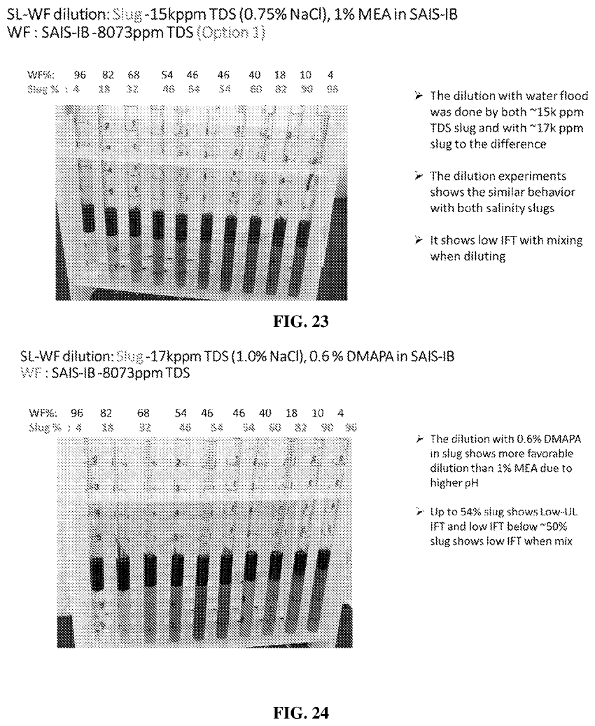

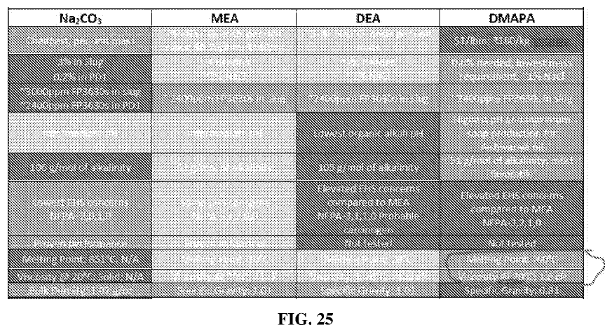

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

### General Definitions

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed.

Other than where noted, all numbers expressing quantities of ingredients, reaction conditions, geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

As used in this specification and the following claims, the terms “comprise” (as well as forms, derivatives, or variations thereof, such as “comprising” and “comprises”) and “include” (as well as forms, derivatives, or variations thereof, such as “including” and “includes”) are inclusive (i.e., open-ended) and do not exclude additional elements or steps. For example, the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof. Accordingly, these terms are intended to not only cover the recited element(s) or step(s), but may also include other elements or steps not expressly recited. Furthermore, as used herein, the use of the terms “a”, “an”, and “the” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent of the given numeric value provided such a deviation does not alter the end function or result of the value. Therefore, a value of about 1% can be construed to be a range from 0.9% to 1.1%. Furthermore, a range may be construed to include the start and the end of the range. For example, a range of 10% to 20% (i.e., range of 10%-20%) can includes 10% and also includes 20%, and includes percentages in between 10% and 20%, unless explicitly stated otherwise herein.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed.

As used herein, the terms “may,” “optionally,” and “may optionally” are used interchangeably and are meant to include cases in which the condition occurs as well as cases in which the condition does not occur. Thus, for example, the statement that a formulation “may include an excipient” is meant to include cases in which the formulation includes an excipient as well as cases in which the formulation does not include an excipient.

The term “contacting” as used herein, refers to materials or compounds being sufficiently close in proximity to react or interact. For example, in methods of contacting an unrefined petroleum material, a hydrocarbon material bearing formation, and/or a well bore, the term “contacting” can include placing a compound (e.g., a surfactant) or an aqueous composition (e.g., chemical, surfactant or polymer) within a hydrocarbon material-bearing formation using any suitable manner known in the art (e.g., pumping, injecting, pouring, releasing, displacing, spotting or circulating the chemical into a well, well bore or hydrocarbon bearing formation).

The terms “unrefined petroleum” and “crude oil” are used interchangeably and in keeping with the plain ordinary usage of those terms. “Unrefined petroleum” and “crude oil” may be found in a variety of petroleum reservoirs (also referred to herein as a “reservoir,” “oil field deposit” “deposit” and the like) and in a variety of forms including oleaginous materials, oil shales (i.e., organic-rich fine-grained sedimentary rock), tar sands, light oil deposits, heavy oil deposits, and the like. “Crude oils” or “unrefined petroleums” generally refer to a mixture of naturally occurring hydrocarbons that may be refined into diesel, gasoline, heating oil, jet fuel, kerosene, and other products called fuels or petrochemicals. Crude oils or unrefined petroleums are named according to their contents and origins, and are classified according to their per unit weight (specific gravity). Heavier crudes generally yield more heat upon burning, but have lower gravity as defined by the American Petroleum Institute (API) (i.e., API gravity) and market price in comparison to light (or sweet) crude oils. Crude oil may also be characterized by its Equivalent Alkane Carbon Number (EACN). The term “API gravity” refers to the measure of how heavy or light a petroleum liquid is compared to water. If an oil's API gravity is greater than 10, it is lighter and floats on water, whereas if it is less than 10, it is heavier and sinks. API gravity is thus an inverse measure of the relative density of a petroleum liquid and the density of water. API gravity may also be used to compare the relative densities of petroleum liquids. For example, if one petroleum liquid floats on another and is therefore less dense, it has a greater API gravity.

Crude oils vary widely in appearance and viscosity from field to field. They range in color, odor, and in the properties they contain. While all crude oils are mostly hydrocarbons, the differences in properties, especially the variation in molecular structure, determine whether a crude oil is more or less easy to produce, pipeline, and refine. The variations may even influence its suitability for certain products and the quality of those products. Crude oils are roughly classified into three groups, according to the nature of the hydrocarbons they contain. (i) Paraffin-based crude oils contain higher molecular weight paraffins, which are solid at room temperature, but little or no asphaltic (bituminous) matter. They can produce high-grade lubricating oils. (ii) Asphaltene based crude oils contain large proportions of asphaltic matter, and little or no paraffin. Some are predominantly naphthenes and so yield lubricating oils that are sensitive to temperature changes than the paraffin-based crudes. (iii) Mixed based crude oils contain both paraffin and naphthenes, as well as aromatic hydrocarbons. Most crude oils fit this latter category.

“Reactive” crude oil, as referred to herein, is crude oil containing natural organic acidic components (also referred to herein as unrefined petroleum acid) or their precursors such as esters or lactones. These reactive crude oils can generate soaps (carboxylates) when reacted with alkali. More terms used interchangeably for crude oil throughout this disclosure are hydrocarbon material or active petroleum material. An “oil bank” or “oil cut” as referred to herein, is the crude oil that does not contain the injected chemicals and is pushed by the injected fluid during an enhanced oil recovery process. A “nonactive oil,” as used herein, refers to an oil that is not substantially reactive or crude oil not containing significant amounts of natural organic acidic components or their precursors such as esters or lactones such that significant amounts of soaps are generated when reacted with alkali. A nonactive oil as referred to herein includes oils having an acid number of less than 0.5 mg KOH/g of oil.

“Unrefined petroleum acids” as referred to herein are carboxylic acids contained in active petroleum material (reactive crude oil). The unrefined petroleum acids contain C₁-C₂₀ alkyl chains, including napthenic acid mixtures. The recovery of such “reactive” oils may be performed using alkali (e.g., NaOH or Na₂CO₃) in a surfactant composition. The alkali reacts with the acid in the reactive oil to form soap in situ. These in situ generated soaps serve as a source of surfactants minimizing the levels of added surfactants, thus enabling efficient oil recovery from the reservoir.

The term “polymer” refers to a molecule having a structure that essentially includes the multiple repetitions of units derived, actually or conceptually, from molecules of low relative molecular mass. In some embodiments, the polymer is an oligomer.

The term “productivity” as applied to a petroleum or oil well refers to the capacity of a well to produce hydrocarbons (e.g., unrefined petroleum); that is, the ratio of the hydrocarbon flow rate to the pressure drop, where the pressure drop is the difference between the average reservoir pressure and the flowing bottom hole well pressure (i.e., flow per unit of driving force).

The term “oil solubilization ratio” is defined as the volume of oil solubilized divided by the volume of surfactant in microemulsion. All the surfactant is presumed to be in the microemulsion phase. The oil solubilization ratio is applied for Winsor type I and type III behavior. The volume of oil solubilized is found by reading the change between initial aqueous level and excess oil (top) interface level. The oil solubilization ratio is calculated as follows:

$${σ}_{o} = \frac{{V}_{o}}{{V}_{s}}$$

where σₒ is the oil solubilization ratio, Vₒ is the volume of oil solubilized, and Vs is the volume of surfactant.

The term “water solubilization ratio” is defined as the volume of water solubilized divided by the volume of surfactant in microemulsion. All the surfactant is presumed to be in the microemulsion phase. The water solubilization ratio is applied for Winsor type III and type II behavior. The volume of water solubilized is found by reading the change between initial aqueous level and excess water (bottom) interface level. The water solubilization parameter is calculated as follows:

$${σ}_{w} = \frac{{V}_{w}}{{V}_{s}}$$

where σ_{w} is the water solubilization ratio, V_{w} is the volume of oil solubilized, and Vs is the volume of surfactant.

The optimum solubilization ratio occurs where the oil and water solubilization ratios are equal. The coarse nature of phase behavior screening often does not include a data point at optimum, so the solubilization ratio curves are drawn for the oil and water solubilization ratio data and the intersection of these two curves is defined as the optimum. The following is true for the optimum solubilization ratio:

$${σ}_{o} = {σ}_{w} = {σ}^{*}$$

where σ* is the optimum solubilization ratio.

The term “solubility” or “solubilization” in general refers to the property of a solute, which can be a solid, liquid or gas, to dissolve in a solid, liquid or gaseous solvent thereby forming a homogenous solution of the solute in the solvent. Solubility occurs under dynamic equilibrium, which means that solubility results from the simultaneous and opposing processes of dissolution and phase joining (e.g., precipitation of solids). The solubility equilibrium occurs when the two processes proceed at a constant rate. The solubility of a given solute in a given solvent typically depends on temperature. For many solids dissolved in liquid water, the solubility increases with temperature. In liquid water at high temperatures, the solubility of ionic solutes tends to decrease due to the change of properties and structure of liquid water. In more particular, solubility and solubilization as referred to herein is the property of oil to dissolve in water and vice versa.

“Viscosity” refers to a fluid's internal resistance to flow or being deformed by shear or tensile stress. In other words, viscosity may be defined as thickness or internal friction of a liquid. Thus, water is “thin”, having a lower viscosity, while oil is “thick”, having a higher viscosity. More generally, the less viscous a fluid is, the greater its ease of fluidity.

The term “salinity” as used herein, refers to concentration of salt dissolved in an aqueous phases. Examples for such salts are without limitation, sodium chloride, magnesium and calcium sulfates, and bicarbonates. In more particular, the term salinity as it pertains to the present invention refers to the concentration of salts in brine and surfactant solutions.

The term “aqueous solution or aqueous formulation” refers to a solution in which the solvent is water. The term “emulsion, emulsion solution or emulsion formulation” refers to a mixture of two or more liquids which are normally immiscible. A non-limiting example for an emulsion is a mixture of oil and water.

The term “co-solvent,” as used herein, refers to a compound having the ability to increase the solubility of a solute (e.g., a surfactant as disclosed herein) in the presence of an unrefined petroleum acid. In some embodiments, the co-solvents provided herein have a hydrophobic portion (alkyl or aryl chain), a hydrophilic portion (e.g., an alcohol) and an alkoxy portion.

The term “interfacial tension” or “IFT” as used herein refers to the surface tension between test oil and water of different salinities containing a surfactant formulation at different concentrations. Typically, interfacial tensions are measured using a spinning drop tensiometer or calculated from phase behavior experiments.

The term “contacting” as used herein, refers to materials or compounds being sufficiently close in proximity to react or interact. For example, in methods of contacting an unrefined petroleum material, a hydrocarbon-bearing formation, and/or a wellbore, the term “contacting” can include placing a compound (e.g., a surfactant) or an aqueous composition (e.g., chemical, surfactant or polymer) within a hydrocarbon-bearing formation using any suitable manner known in the art (e.g., pumping, injecting, pouring, releasing, displacing, spotting or circulating the chemical into a well, wellbore or hydrocarbon-bearing formation).

The term “live oil,” as used herein, refers generally to an oil containing dissolved gas (e.g., methane) in solution.

Compounds disclosed herein may be provided in the form of physiologically acceptable salts. Examples of such salts are acid addition salts formed with inorganic acids, for example, hydrochloric, hydrobromic, sulfuric, phosphoric, and nitric acids and the like; salts formed with organic acids such as acetic, oxalic, tartaric, succinic, maleic, fumaric, gluconic, citric, malic, methanesulfonic, p-toluenesulfonic, napthalenesulfonic, and polygalacturonic acids, and the like; salts formed from elemental anions such as chloride, bromide, and iodide; salts formed from metal hydroxides, for example, sodium hydroxide, potassium hydroxide, calcium hydroxide, lithium hydroxide, and magnesium hydroxide; salts formed from metal carbonates, for example, sodium carbonate, potassium carbonate, calcium carbonate, and magnesium carbonate; salts formed from metal bicarbonates, for example, sodium bicarbonate and potassium bicarbonate; salts formed from metal sulfates, for example, sodium sulfate and potassium sulfate; and salts formed from metal nitrates, for example, sodium nitrate and potassium nitrate.

Compounds described herein can comprise one or more asymmetric centers, and thus can exist in various stereoisomeric forms, e.g., enantiomers and/or diastereomers. For example, the compounds described herein can be in the form of an individual enantiomer, diastereomer or geometric isomer, or can be in the form of a mixture of stereoisomers, including racemic mixtures and mixtures enriched in one or more stereoisomer. Isomers can be isolated from mixtures by methods known to those skilled in the art, including chiral high pressure liquid chromatography (HPLC) and the formation and crystallization of chiral salts; or preferred isomers can be prepared by asymmetric syntheses. See, for example, Jacques et al., Enantioners, Raceniates and Resolutions, Wiley Interscience, New York, 1981; Wilen et al., Tetrahedron 33:2725 (1977); Eliel, E. L. Stereochemistry of Carbon Compounds, McGraw-Hill, NY, 1962; and Wilen, S. H., Tables of Resolving Agents and Optical Resolutions p. 268, E. L. Eliel, Ed., Univ. of Notre Dame Press, Notre Dame, IN 1972. The invention additionally encompasses compounds as individual isomers substantially free of other isomers, and alternatively, as mixtures of various isomers.

When a range of values is listed, it is intended to encompass each value and sub-range within the range. For example, “C₁₋₆ alkyl” is intended to encompass C₁, C₂, C₃, C₄, C₅, C₆, C₁₋₆, C₁₋₅, C₁₋₄, C₁₋₃, C₁₋₂, C₂₋₆, C₂₋₅, C₂₋₄, C₂₋₃, C₃₋₆, C₃₋₅, C₃₋₄, C₄₋₆, C₄₋₅, and C₅₋₆ alkyl.

The term “alkyl” refers to a radical of a straight-chain or branched hydrocarbon group having a specified range of carbon atoms (e.g., a “C₁₋₁₆ alkyl” can have from 1 to 16 carbon atoms). In some embodiments, an alkyl group has 1 to 9 carbon atoms (“C₁₋₉ alkyl”). An alkyl group can be saturated or unsaturated, i.e., an alkenyl or alkynyl group as defined herein. Unless specified to the contrary, an “alkyl” group includes both saturated alkyl groups and unsaturated alkyl groups.

In some embodiments, an alkyl group has 1 to 8 carbon atoms (“C₁₋₈ alkyl”). In some embodiments, an alkyl group has 1 to 7 carbon atoms (“C₁₋₇ alkyl”). In some embodiments, an alkyl group has 1 to 6 carbon atoms (“C₁₋₆ alkyl”). In some embodiments, an alkyl group has 1 to 5 carbon atoms (“C₁₋₅ alkyl”). In some embodiments, an alkyl group has 1 to 4 carbon atoms (“C₁₋₄ alkyl”). In some embodiments, an alkyl group has 1 to 3 carbon atoms (“C₁₋₃ alkyl”). In some embodiments, an alkyl group has 1 to 2 carbon atoms (“C₁₋₂ alkyl”). In some embodiments, an alkyl group has 1 carbon atom (“C₁ alkyl”). In some embodiments, an alkyl group has 2 to 6 carbon atoms (“C₂₋₆ alkyl”). Examples of C₁₋₆ alkyl groups include methyl (C₁), ethyl (C₂), propyl (C₃) (e.g., n-propyl, isopropyl), butyl (C₄) (e.g., n-butyl, tert-butyl, sec-butyl, iso-butyl), pentyl (C₅) (e.g., n-pentyl, 3-pentanyl, amyl, neopentyl, 3-methyl-2-butanyl, tertiary amyl), and hexyl (C₆) (e.g., n-hexyl). Additional examples of alkyl groups include n-heptyl (C₇), n-octyl (C₈), and the like. Unless otherwise specified, each instance of an alkyl group is independently unsubstituted (an “unsubstituted alkyl”) or substituted (a “substituted alkyl”) with one or more substituents (e.g., halogen, such as F). In certain embodiments, the alkyl group is an unsubstituted C₁₋₁₀ alkyl (such as unsubstituted C₁₋₆ alkyl, e.g., —CH₃ (Me), unsubstituted ethyl (Et), unsubstituted propyl (Pr, e.g., unsubstituted n-propyl (n-Pr), unsubstituted isopropyl (i-Pr)), unsubstituted butyl (Bu, e.g., unsubstituted n-butyl (n-Bu), unsubstituted tert-butyl (tert-Bu or t-Bu), unsubstituted sec-butyl (sec-Bu), unsubstituted isobutyl (i-Bu)). In certain embodiments, the alkyl group is a substituted C₁₋₁₀ alkyl (such as substituted C₁₋₆ alkyl, e.g., —CF₃, Bn).

The term “haloalkyl” is a substituted alkyl group, wherein one or more of the hydrogen atoms are independently replaced by a halogen, e.g., fluoro, bromo, chloro, or iodo. In some embodiments, the haloalkyl moiety has 1 to 8 carbon atoms (“C₁₋₈ haloalkyl”). In some
embodiments, the haloalkyl moiety has 1 to 6 carbon atoms (“C₁₋₆ haloalkyl”). In some embodiments, the haloalkyl moiety has 1 to 4 carbon atoms (“C₁₋₄ haloalkyl”). In some embodiments, the haloalkyl moiety has 1 to 3 carbon atoms (“C₁₋₃ haloalkyl”). In some embodiments, the haloalkyl moiety has 1 to 2 carbon atoms (“C₁₋₂ haloalkyl”). Examples of haloalkyl groups include —CHF₂, —CH₂F, —CF₃, —CH₂CF₃, —CF₂CF₃, —CF₂CF₂CF₃, —CCl₃, —CFCl₂, —CF₂Cl, and the like.

The term “hydroxyalkyl” is a substituted alkyl group, wherein one or more of the hydrogen atoms are independently replaced by a hydroxyl. In some embodiments, the hydroxyalkyl moiety has 1 to 8 carbon atoms (“C₁₋₈ hydroxyalkyl”). In some embodiments, the
hydroxyalkyl moiety has 1 to 6 carbon atoms (“C₁₋₆ hydroxyalkyl”). In some embodiments, the hydroxyalkyl moiety has 1 to 4 carbon atoms (“C₁₋₄ hydroxyalkyl”). In some embodiments, the hydroxyalkyl moiety has 1 to 3 carbon atoms (“C₁₋₃ hydroxyalkyl”). In some embodiments, the hydroxyalkyl moiety has 1 to 2 carbon atoms (“C₁₋₂ hydroxyalkyl”).

The term “alkoxy” refers to an alkyl group, as defined herein, appended through an oxygen atom. In some embodiments, the alkoxy moiety has 1 to 8 carbon atoms (“C₁₋₈ alkoxy”). In some embodiments, the alkoxy moiety has 1 to 6 carbon atoms (“C₁₋₆ alkoxy”). In some embodiments, the alkoxy moiety has 1 to 4 carbon atoms (“C₁₋₄ alkoxy”). In some embodiments, the alkoxy moiety has 1 to 3 carbon atoms (“C₁₋₃ alkoxy”). In some embodiments, the alkoxy moiety has 1 to 2 carbon atoms (“C₁₋₂ alkoxy”). Representative examples of alkoxy include, but are not limited to, methoxy, ethoxy, propoxy, 2-propoxy, butoxy and tert-butoxy.

The term “haloalkoxy” refers to a haloalkyl group, as defined herein, appended through an oxygen atom. In some embodiments, the alkoxy moiety has 1 to 8 carbon atoms (“C₁₋₈ haloalkoxy”). In some embodiments, the alkoxy moiety has 1 to 6 carbon atoms (“C₁₋₆ haloalkoxy”). In some embodiments, the alkoxy moiety has 1 to 4 carbon atoms (“C₁₋₄ haloalkoxy”). In some embodiments, the alkoxy moiety has 1 to 3 carbon atoms (“C₁₋₃ haloalkoxy”). In some embodiments, the alkoxy moiety has 1 to 2 carbon atoms (“C₁₋₂ haloalkoxy”). Representative examples of haloalkoxy include, but are not limited to, difluoromethoxy, trifluoromethoxy, and 2,2,2-trifluoroethoxy.

The term “alkoxyalkyl” is a substituted alkyl group, wherein one or more of the hydrogen atoms are independently replaced by an alkoxy group, as defined herein. In some embodiments, the alkoxyalkyl moiety has 1 to 8 carbon atoms (“C₁₋₈ alkoxyalkyl”). In some embodiments, the alkoxyalkyl moiety has 1 to 6 carbon atoms (“C₁₋₆ alkoxyalkyl”). In some embodiments, the alkoxyalkyl moiety has 1 to 4 carbon atoms (“C₁₋₄ alkoxyalkyl”). In some embodiments, the alkoxyalkyl moiety has 1 to 3 carbon atoms (“C₁₋₃ alkoxyalkyl”). In some embodiments, the alkoxyalkyl moiety has 1 to 2 carbon atoms (“C₁₋₂ alkoxyalkyl”). By way of example, a C₃alkoxyC₃alkyl group includes, but is not limited to, the groups having the formula:

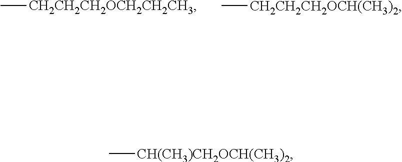

The term “heteroalkyl” refers to an alkyl group, which further includes at least one heteroatom (e.g., 1, 2, 3, or 4 heteroatoms) selected from oxygen, nitrogen, or sulfur within (i.e., inserted between adjacent carbon atoms of) and/or placed at one or more terminal position(s) of the parent chain. By way of example, a heteroC₁₋₆alkyl (which may also be designated a C₁₋₆heteroalkyl) group includes, but is not limited to, the following structures:

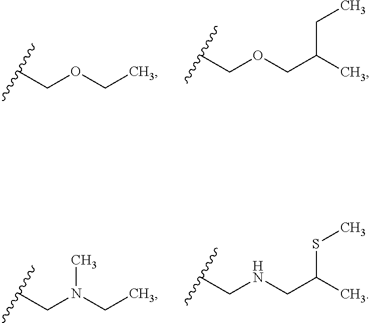

The term “heteroalkyl” preceded by a separate heteroatom refers to a heteroalkyl group bonded through the specified heteroatom. By way of example, a OC₁₋₆heteroalkyl group includes, but it not limited to, the following structures:

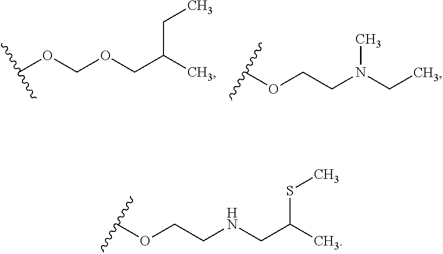

In certain embodiments, a heteroalkyl group refers to a saturated group having from 1 to 20 carbon atoms and 1 or more heteroatoms within the parent chain (“heteroC₁₋₂₀ alkyl”). In some embodiments, a heteroalkyl group is a saturated group having 1 to 18 carbon atoms and lor more heteroatoms within the parent chain (“heteroC₁₋₁₈ alkyl”). In some embodiments, a heteroalkyl group is a saturated group having 1 to 16 carbon atoms and/or more heteroatoms within the parent chain (“heteroC₁₋₆ alkyl”). In some embodiments, a heteroalkyl group is a saturated group having 1 to 14 carbon atoms and 1 or more heteroatoms within the parent chain (“heteroC₁₋₄ alkyl”). In some embodiments, a heteroalkyl group is a saturated group having 1 to 12 carbon atoms and 1 or more heteroatoms within the parent chain (“heteroC₁₋₁₂ alkyl”). In some embodiments, a heteroalkyl group is a saturated group having Ito 10 carbon atoms and lor more heteroatoms within the parent chain (“heteroC₁₋₁₀ alkyl”). In some embodiments, a heteroalkyl group is a saturated group having 1 to 8 carbon atoms and 1 or more heteroatoms within the parent chain (“heteroC₁₋₈ alkyl”). In some embodiments, a heteroalkyl group is a saturated group having 1 to 6 carbon atoms and 1 or more heteroatoms within the parent chain (“heteroC₁₋₆ alkyl”). In some embodiments, a heteroalkyl group is a saturated group having 1 to 4 carbon atoms and 1 or 2 heteroatoms within the parent chain (“heteroC₁₋₄ alkyl”). In some embodiments, a heteroalkyl group is a saturated group having 1 to 3 carbon atoms and 1 heteroatom within the parent chain (“heteroC₁₋₃alkyl”). In some embodiments, a heteroalkyl group is a saturated group having 1 to 2 carbon atoms and 1 heteroatom within the parent chain (“heteroC₁₋₂alkyl”). In some embodiments, a heteroalkyl group is a saturated group having 1 carbon atom and 1 heteroatom (“heteroC₁alkyl”). In some embodiments, the heteroalkyl group defined herein is a partially unsaturated group having 1 or more heteroatoms within the parent chain and at least one unsaturated carbon, such as a carbonyl group. For example, a heteroalkyl group may comprise an amide or ester functionality in its parent chain such that one or more carbon atoms are unsaturated carbonyl groups. Unless otherwise specified, each instance of a heteroalkyl group is independently unsubstituted (an “unsubstituted heteroalkyl”) or substituted (a “substituted heteroalkyl”) with one or more substituents. In certain embodiments, the heteroalkyl group is an unsubstituted heteroC₁₋₂₀alkyl. In certain embodiments, the heteroalkyl group is an unsubstituted heteroC₁₋₁₀alkyl. In certain embodiments, the heteroalkyl group is a substituted heteroC₁₋₂₀alkyl. In certain embodiments, the heteroalkyl group is an unsubstituted heteroC₁₋₁₀alkyl.

The term “alkenyl” refers to a radical of a straight-chain or branched hydrocarbon group having from 2 to 10 carbon atoms and one or more carbon-carbon double bonds (e.g., 1, 2, 3, or 4 double bonds). In some embodiments, an alkenyl group has 2 to 9 carbon atoms (“C₂₋₉ alkenyl”). In some embodiments, an alkenyl group has 2 to 8 carbon atoms (“C₂₋₈ alkenyl”). In some embodiments, an alkenyl group has 2 to 7 carbon atoms (“C₂₋₇ alkenyl”). In some embodiments, an alkenyl group has 2 to 6 carbon atoms (“C₂₋₆alkenyl”). In some embodiments, an alkenyl group has 2 to 5 carbon atoms (“C₂₋₅alkenyl”). In some embodiments, an alkenyl group has 2 to 4 carbon atoms (“C₂₋₄alkenyl”). In some embodiments, an alkenyl group has 2 to 3 carbon atoms (“C₂₋₃alkenyl”). In some embodiments, an alkenyl group has 2 carbon atoms (“C₂ alkenyl”). The one or more carbon-carbon double bonds can be internal (such as in 2-butenyl) or terminal (such as in 1-butenyl). Examples of C₂₋₄ alkenyl groups include ethenyl (C₂), 1-propenyl (C₃), 2-propenyl (C₃), 1-butenyl (C₄), 2-butenyl (C₄), butadienyl (C₄), and the like. Examples of C₂₋₆ alkenyl groups include the aforementioned C₂₋₄ alkenyl groups as well as pentenyl (C₅), pentadienyl (C₅), hexenyl (C₆), and the like. Additional examples of alkenyl include heptenyl (C₇), octenyl (C₈), octatrienyl (C₈), and the like. Unless otherwise specified, each instance of an alkenyl group is independently unsubstituted (an “unsubstituted alkenyl”) or substituted (a “substituted alkenyl”) with one or more substituents. In certain embodiments, the alkenyl group is an unsubstituted C₂₋₁₀ alkenyl. In certain embodiments, the alkenyl group is a substituted C₂₋₁₀ alkenyl. In an alkenyl group, a C═C double bond for which the stereochemistry is not specified

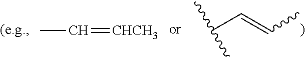

may be an (E)- or (Z)-double bond.

The term “heteroalkenyl” refers to an alkenyl group, which further includes at least one heteroatom (e.g., 1, 2, 3, or 4 heteroatoms) selected from oxygen, nitrogen, or sulfur within (i.e., inserted between adjacent carbon atoms of) and/or placed at one or more terminal position(s) of the parent chain. In certain embodiments, a heteroalkenyl group refers to a group having from 2 to 10 carbon atoms, at least one double bond, and 1 or more heteroatoms within the parent chain (“heteroC₂₋₁₀alkenyl”). In some embodiments, a heteroalkenyl group has 2 to 9 carbon atoms at least one double bond, and 1 or more heteroatoms within the parent chain (“heteroC₂₋₉alkenyl”).

In some embodiments, a heteroalkenyl group has 2 to 8 carbon atoms, at least one double bond, and 1 or more heteroatoms within the parent chain (“heteroC₂₋₈alkenyl”). In some embodiments, a heteroalkenyl group has 2 to 7 carbon atoms, at least one double bond, and 1 or more heteroatoms within the parent chain (“heteroC₂₋₇alkenyl”). In some embodiments, a heteroalkenyl group has 2 to 6 carbon atoms, at least one double bond, and 1 or more heteroatoms within the parent chain (“heteroC₂₋₆alkenyl”). In some embodiments, a heteroalkenyl group has 2 to 5 carbon atoms, at least one double bond, and 1 or 2 heteroatoms within the parent chain (“heteroC₂₋₅alkenyl”). In some embodiments, a heteroalkenyl group has 2 to 4 carbon atoms, at least one double bond, and 1 or 2 heteroatoms within the parent chain (“heteroC₂₋₄ alkenyl”). In some embodiments, a heteroalkenyl group has 2 to 3 carbon atoms, at least one double bond, and 1 heteroatom within the parent chain (“heteroC₂₋₃alkenyl”). In some embodiments, a heteroalkenyl group has 2 to 6 carbon atoms, at least one double bond, and 1 or 2 heteroatoms within the parent chain (“heteroC₂₋₆alkenyl”). Unless otherwise specified, each instance of a heteroalkenyl group is independently unsubstituted (an “unsubstituted heteroalkenyl”) or substituted (a “substituted heteroalkenyl”) with one or more substituents. In certain embodiments, the heteroalkenyl group is an unsubstituted heteroC₂₋₁₀alkenyl. In certain embodiments, the heteroalkenyl group is a substituted heteroC₂₋₁₀alkenyl.

The term “alkynyl” refers to a radical of a straight-chain or branched hydrocarbon group having from 2 to 10 carbon atoms and one or more carbon-carbon triple bonds (e.g., 1, 2, 3, or 4 triple bonds) (“C₂₋₁₀alkynyl”). In some embodiments, an alkynyl group has 2 to 9 carbon atoms (“C₂₋₉alkynyl”). In some embodiments, an alkynyl group has 2 to 8 carbon atoms (“C₂₋₈alkynyl”).

In some embodiments, an alkynyl group has 2 to 7 carbon atoms (“C₂₋₇alkynyl”). In some embodiments, an alkynyl group has 2 to 6 carbon atoms (“C₂₋₆alkynyl”). In some embodiments, an alkynyl group has 2 to 5 carbon atoms (“C₂₋₅alkynyl”). In some embodiments, an alkynyl group has 2 to 4 carbon atoms (“C₂₋₄alkynyl”). In some embodiments, an alkynyl group has 2 to 3 carbon atoms (“C₂₋₃alkynyl”). In some embodiments, an alkynyl group has 2 carbon atoms (“C₂ alkynyl”). The one or more carbon-carbon triple bonds can be internal (such as in 2-butynyl) or terminal (such as in 1-butynyl). Examples of C₂₋₄ alkynyl groups include, without limitation, ethynyl (C₂), 1-propynyl (C₃), 2-propynyl (C₃), 1-butynyl (C₄), 2-butynyl (C₄), and the like. Examples of C₂₋₆ alkenyl groups include the aforementioned C₂₋₄ alkynyl groups as well as pentynyl (C₅), hexynyl (C₆), and the like. Additional examples of alkynyl include heptynyl (C₇), octynyl (C₈), and the like. Unless otherwise specified, each instance of an alkynyl group is independently unsubstituted (an “unsubstituted alkynyl”) or substituted (a “substituted alkynyl”) with one or more substituents. In certain embodiments, the alkynyl group is an unsubstituted C₂₋₁₀ alkynyl. In certain embodiments, the alkynyl group is a substituted C₂₋₁₀ alkynyl.

The term “heteroalkynyl” refers to an alkynyl group, which further includes at least one heteroatom (e.g., 1, 2, 3, or 4 heteroatoms) selected from oxygen, nitrogen, or sulfur within (i.e., inserted between adjacent carbon atoms of) and/or placed at one or more terminal position(s) of the parent chain. In certain embodiments, a heteroalkynyl group refers to a group having from 2 to 10 carbon atoms, at least one triple bond, and 1 or more heteroatoms within the parent chain (“heteroC₂₋₁₀alkynyl”). In some embodiments, a heteroalkynyl group has 2 to 9 carbon atoms, at least one triple bond, and lor more heteroatoms within the parent chain (“heteroC₂₋₉alkynyl”). In some embodiments, a heteroalkynyl group has 2 to 8 carbon atoms, at least one triple bond, and lor more heteroatoms within the parent chain (“heteroC₂₋₈alkynyl”). In some embodiments, a heteroalkynyl group has 2 to 7 carbon atoms, at least one triple bond, and 1 or more heteroatoms within the parent chain (“heteroC₂₋₇alkynyl”). In some embodiments, a heteroalkynyl group has 2 to 6 carbon atoms, at least one triple bond, and 1 or more heteroatoms within the parent chain (“heteroC₂₋₆alkynyl”). In some embodiments, a heteroalkynyl group has 2 to 5 carbon atoms, at least one triple bond, and 1 or 2 heteroatoms within the parent chain (“heteroC₂₋₅alkynyl”). In some embodiments, a heteroalkynyl group has 2 to 4 carbon atoms, at least one triple bond, and 1 or 2 heteroatoms within the parent chain (“heteroC₂₋₄alkynyl”). In some embodiments, a heteroalkynyl group has 2 to 3 carbon atoms, at least one triple bond, and 1 heteroatom within the parent chain (“heteroC₂₋₃alkynyl”). In some embodiments, a heteroalkynyl group has 2 to 6 carbon atoms, at least one triple bond, and 1 or 2 heteroatoms within the parent chain (“heteroC₂₋₆alkynyl”). Unless otherwise specified, each instance of a heteroalkynyl group is independently unsubstituted (an “unsubstituted heteroalkynyl”) or substituted (a “substituted heteroalkynyl”) with one or more substituents. In certain embodiments, the heteroalkynyl group is an unsubstituted heteroC₂₋₁₀alkynyl. In certain embodiments, the heteroalkynyl group is a substituted heteroC₂₋₁₀alkynyl.

The term “carbocyclyl,” “cycloalkyl,” or “carbocyclic” refers to a radical of a non-aromatic cyclic hydrocarbon group having from 3 to 14 ring carbon atoms (“C₃₋₄carbocyclyl”) and zero heteroatoms in the non-aromatic ring system. In some embodiments, a carbocyclyl group has 3 to 10 ring carbon atoms (“C₃₋₁₀carbocyclyl”). In some embodiments, a carbocyclyl group has 3 to 8 ring carbon atoms (“C₃₋₈carbocyclyl”). In some embodiments, a carbocyclyl group has 3 to 7 ring carbon atoms (“C₃₋₇carbocyclyl”). In some embodiments, a carbocyclyl group has 3 to 6 ring carbon atoms (“C₃₋₆carbocyclyl”). In some embodiments, a carbocyclyl group has 4 to 6 ring carbon atoms (“C₄₋₆carbocyclyl”). In some embodiments, a carbocyclyl group has 5 to 6 ring carbon atoms (“C₅₋₆carbocyclyl”). In some embodiments, a carbocyclyl group has 5 to 10 ring carbon atoms (“C₅₋₁₀carbocyclyl”). Exemplary C₃₋₆ carbocyclyl groups include, without limitation, cyclopropyl (C₃), cyclopropenyl (C₃), cyclobutyl (C₄), cyclobutenyl (C₄), cyclopentyl (C₅), cyclopentenyl (C₅), cyclohexyl (C₆), cyclohexenyl (C₆), cyclohexadienyl (C₆), and the like.

Exemplary C₃₋₈carbocyclyl groups include, without limitation, the aforementioned C₃₋₆ carbocyclyl groups as well as cycloheptyl (C₇), cycloheptenyl (C₇), cycloheptadienyl (C₇), cycloheptatrienyl (C₇), cyclooctyl (C₈), cyclooctenyl (C₈), bicyclo[2.2.1]heptanyl (C₇), bicyclo[2.2.2]octanyl (C₈), and the like. Exemplary C₃₋₁₀ carbocyclyl groups include, without limitation, the aforementioned C₃₋₈ carbocyclyl groups as well as cyclononyl (C₉), cyclononenyl
(C₉), cyclodecyl (C₁₀), cyclodecenyl (C₁₀), octahydro-1H-indenyl (C₉), decahydronaphthalenyl (C₁₀), spiro[4.5]decanyl (C₁₀), and the like. As the foregoing examples illustrate, in certain embodiments, the carbocyclyl group is either monocyclic (“monocyclic carbocyclyl”) or polycyclic (e.g., containing a fused, bridged or spiro ring system such as a bicyclic system (“bicyclic carbocyclyl”) or tricyclic system (“tricyclic carbocyclyl”)) and can be saturated or can contain one or more carbon-carbon double or triple bonds. “Carbocyclyl” also includes ring systems wherein the carbocyclyl ring, as defined above, is fused with one or more aryl or heteroaryl groups wherein the point of attachment is on the carbocyclyl ring, and in such instances, the number of carbons continue to designate the number of carbons in the carbocyclic ring system. Unless otherwise specified, each instance of a carbocyclyl group is independently unsubstituted (an “unsubstituted carbocyclyl”) or substituted (a “substituted carbocyclyl”) with one or more substituents. In certain embodiments, the carbocyclyl group is an unsubstituted C₃₋₁₄ carbocyclyl. In certain embodiments, the carbocyclyl group is a substituted C₃₋₁₄ carbocyclyl.

In some embodiments, “carbocyclyl” is a monocyclic, saturated carbocyclyl group having from 3 to 14 ring carbon atoms (“C₃₋₁₄cycloalkyl”). In some embodiments, a cycloalkyl group has 3 to 10 ring carbon atoms (“C₃₋₁₀cycloalkyl”). In some embodiments, a cycloalkyl group has 3 to 8 ring carbon atoms (“C₃₋₈cycloalkyl”). In some embodiments, a cycloalkyl group has 3 to 6 ring carbon atoms (“C₃₋₆cycloalkyl”). In some embodiments, a cycloalkyl group has 4 to 6 ring carbon atoms (“C₄₋₆cycloalkyl”). In some embodiments, a cycloalkyl group has 5 to 6 ring carbon atoms (“C₅₋₆cycloalkyl”). In some embodiments, a cycloalkyl group has 5 to 10 ring carbon atoms (“C₅₋₁₀cycloalkyl”). Examples of C₅₋₆ cycloalkyl groups include cyclopentyl (C₅) and cyclohexyl (C₆). Examples of C₃₋₆ cycloalkyl groups include the aforementioned C₅₋₆ cycloalkyl groups as well as cyclopropyl (C₃) and cyclobutyl (C₄). Examples of C₃₋₈ cycloalkyl groups include the aforementioned C₃₋₆ cycloalkyl groups as well as cycloheptyl (C₇) and cyclooctyl (C₈). Unless otherwise specified, each instance of a cycloalkyl group is independently unsubstituted (an “unsubstituted cycloalkyl”) or substituted (a “substituted cycloalkyl”) with one or more substituents. In certain embodiments, the cycloalkyl group is an unsubstituted C₃₋₁₄ cycloalkyl. In certain embodiments, the cycloalkyl group is a substituted C₃₋₁₄ cycloalkyl.

As used herein, the term “heterocyclyl” refers to an aromatic (also referred to as a heteroaryl), unsaturated, or saturated cyclic hydrocarbon that includes at least one heteroatom in the cycle. For example, the term “heterocyclyl” or “heterocyclic” refers to a radical of a 3- to 14-membered non-aromatic ring system having ring carbon atoms and 1 to 4 ring heteroatoms, wherein each heteroatom is independently selected from nitrogen, oxygen, and sulfur (“3-14 membered heterocyclyl”). In heterocyclyl groups that contain one or more nitrogen atoms, the point of attachment can be a carbon or nitrogen atom, as valency permits. A heterocyclyl group can either be monocyclic (“monocyclic heterocyclyl”) or polycyclic (e.g., a fused, bridged or spiro ring system such as a bicyclic system (“bicyclic heterocyclyl”) or tricyclic system (“tricyclic heterocyclyl”)), and can be saturated or can contain one or more carbon-carbon double or triple bonds. Heterocyclyl polycyclic ring systems can include one or more heteroatoms in one or both rings. “Heterocyclyl” also includes ring systems wherein the heterocyclyl ring, as defined above, is fused with one or more carbocyclyl groups wherein the point of attachment is either on the carbocyclyl or heterocyclyl ring, or ring systems wherein the heterocyclyl ring, as defined above, is fused with one or more aryl or heteroaryl groups, wherein the point of attachment is on the heterocyclyl ring, and in such instances, the number of ring members continue to designate the number of ring members in the heterocyclyl ring system. Unless otherwise specified, each instance of heterocyclyl is independently unsubstituted (an “unsubstituted heterocyclyl”) or substituted (a “substituted heterocyclyl”) with one or more substituents. In certain embodiments, the heterocyclyl group is an unsubstituted 3-14 membered heterocyclyl. In certain embodiments, the heterocyclyl group is a substituted 3-14 membered heterocyclyl.

In some embodiments, a heterocyclyl group is a 5-10 membered non-aromatic ring system having ring carbon atoms and 1-4 ring heteroatoms, wherein each heteroatom is independently selected from nitrogen, oxygen, and sulfur (“5-10 membered heterocyclyl”). In some embodiments, a heterocyclyl group is a 5-8 membered non-aromatic ring system having ring carbon atoms and 1-4 ring heteroatoms, wherein each heteroatom is independently selected from nitrogen, oxygen, and sulfur (“5-8 membered heterocyclyl”). In some embodiments, a heterocyclyl group is a 5-6 membered non-aromatic ring system having ring carbon atoms and 1-4 ring heteroatoms, wherein each heteroatom is independently selected from nitrogen, oxygen, and sulfur (“5-6 membered heterocyclyl”). In some embodiments, the 5-6 membered heterocyclyl has 1-3 ring heteroatoms selected from nitrogen, oxygen, and sulfur. In some embodiments, the 5-6 membered heterocyclyl has 1-2 ring heteroatoms selected from nitrogen, oxygen, and sulfur. In some embodiments, the 5-6 membered heterocyclyl has 1 ring heteroatom selected from nitrogen, oxygen, and sulfur.

Exemplary 3-membered heterocyclyl groups containing 1 heteroatom include, without limitation, aziridinyl, oxiranyl, and thiiranyl. Exemplary 4-membered heterocyclyl groups containing 1 heteroatom include, without limitation, azetidinyl, oxetanyl, and thietanyl. Exemplary 5-membered heterocyclyl groups containing 1 heteroatom include, without limitation, tetrahydrofuranyl, dihydrofuranyl, tetrahydrothiophenyl, dihydrothiophenyl, pyrrolidinyl, dihydropyrrolyl, and pyrrolyl-2,5-dione. Exemplary 5-membered heterocyclyl groups containing 2 heteroatoms include, without limitation, dioxolanyl, oxathiolanyl and dithiolanyl. Exemplary 5-membered heterocyclyl groups containing 3 heteroatoms include, without limitation, triazolinyl, oxadiazolinyl, and thiadiazolinyl. Exemplary 6-membered heterocyclyl groups containing 1 heteroatom include, without limitation, piperidinyl, tetrahydropyranyl, dihydropyridinyl, and thianyl. Exemplary 6-membered heterocyclyl groups containing 2 heteroatoms include, without limitation, piperazinyl, morpholinyl, dithianyl, and dioxanyl. Exemplary 6-membered heterocyclyl groups containing 3 heteroatoms include, without limitation, triazinyl. Exemplary 7-membered heterocyclyl groups containing 1 heteroatom include, without limitation, azepanyl, oxepanyl and thiepanyl. Exemplary 8-membered heterocyclyl groups containing 1 heteroatom include, without limitation, azocanyl, oxecanyl and thiocanyl. Exemplary bicyclic heterocyclyl groups include, without limitation, indolinyl, isoindolinyl, dihydrobenzofuranyl, dihydrobenzothienyl, tetrahydrobenzothienyl, tetrahydrobenzofuranyl, tetrahydroindolyl, tetrahydroquinolinyl, tetrahydroisoquinolinyl, decahydroquinolinyl, decahydroisoquinolinyl, octahydrochromenyl, octahydroisochromenyl, decahydronaphthyridinyl, decahydro-1,8-naphthyridinyl, octahydropyrrolo[3,2-b]pyrrole, indolinyl, phthalimidyl, naphthalimidyl, chromanyl, chromenyl, 1H-benzo[e][1,4]diazepinyl, 1,4,5,7-tetrahydropyrano[3,4-b]pyrrolyl, 5,6-dihydro-4H-furo[3,2-b]pyrrolyl, 6,7-dihydro-5H furo[3,2-b]pyranyl, 5,7-dihydro-4H-thieno[2,3-c]pyranyl, 2,3-dihydro-1H-pyrrolo[2,3-b]pyridinyl, 2,3-dihydrofuro[2,3-b]pyridinyl, 4,5,6,7-tetrahydro-1H-pyrrolo[2,3-b]pyridinyl, 4,5,6,7-tetrahydrofuro[3,2-c]pyridinyl, 4,5,6,7-tetrahydrothieno[3,2-b]pyridinyl, 1,2,3,4-tetrahydro-1,6-naphthyridinyl, and the like.

The term “aryl” refers to a radical of a monocyclic or polycyclic (e.g., bicyclic or tricyclic) 4n+2 aromatic ring system (e.g., having 6, 10, or 14 π electrons shared in a cyclic array) having 6-14 ring carbon atoms and zero heteroatoms provided in the aromatic ring system (“C₆₋₁₄aryl”). In some embodiments, an aryl group has 6 ring carbon atoms (“C₆aryl”; e.g., phenyl). In some embodiments, an aryl group has 10 ring carbon atoms (“C₁₀aryl”; e.g., naphthyl such as 1-naphthyl and 2-naphthyl). In some embodiments, an aryl group has 14 ring carbon atoms (“C₁₄aryl”; e.g., anthracyl). “Aryl” also includes ring systems wherein the aryl ring, as defined above, is fused with one or more carbocyclyl or heterocyclyl groups wherein the radical or point of attachment is on the aryl ring, and in such instances, the number of carbon atoms continue to designate the number of carbon atoms in the aryl ring system. Unless otherwise specified, each instance of an aryl group is independently unsubstituted (an “unsubstituted aryl”) or substituted (a “substituted aryl”) with one or more substituents. In certain embodiments, the aryl group is an unsubstituted C₆₋₁₄aryl. In certain embodiments, the aryl group is a substituted C₆₋₁₄ aryl.

The term “heteroaryl” refers to a radical of a 5-14 membered monocyclic or polycyclic (e.g., bicyclic, tricyclic) 4n+2 aromatic ring system (e.g., having 6, 10, or 14 π electrons shared in a cyclic array) having ring carbon atoms and 1-4 ring heteroatoms provided in the aromatic ring system, wherein each heteroatom is independently selected from nitrogen, oxygen, and sulfur (“5-14 membered heteroaryl”). In heteroaryl groups that contain one or more nitrogen atoms, the point of attachment can be a carbon or nitrogen atom, as valency permits. Heteroaryl polycyclic ring systems can include one or more heteroatoms in one or both rings. “Heteroaryl” includes ring systems wherein the heteroaryl ring, as defined above, is fused with one or more carbocyclyl or heterocyclyl groups wherein the point of attachment is on the heteroaryl ring, and in such instances, the number of ring members continue to designate the number of ring members in the heteroaryl ring system. “Heteroaryl” also includes ring systems wherein the heteroaryl ring, as defined above, is fused with one or more aryl groups wherein the point of attachment is either on the aryl or heteroaryl ring, and in such instances, the number of ring members designates the number of ring members in the fused polycyclic (aryl/heteroaryl) ring system. Polycyclic heteroaryl groups wherein one ring does not contain a heteroatom (e.g., indolyl, quinolinyl, carbazolyl, and the like) the point of attachment can be on either ring, i.e., either the ring bearing a heteroatom (e.g., 2-indolyl) or the ring that does not contain a heteroatom (e.g., 5-indolyl).

In some embodiments, a heteroaryl group is a 5-10 membered aromatic ring system having ring carbon atoms and 1-4 ring heteroatoms provided in the aromatic ring system, wherein each heteroatom is independently selected from nitrogen, oxygen, and sulfur (“5-10 membered heteroaryl”). In some embodiments, a heteroaryl group is a 5-8 membered aromatic ring system having ring carbon atoms and 1-4 ring heteroatoms provided in the aromatic ring system, wherein each heteroatom is independently selected from nitrogen, oxygen, and sulfur (“5-8 membered heteroaryl”). In some embodiments, a heteroaryl group is a 5-6 membered aromatic ring system having ring carbon atoms and 1-4 ring heteroatoms provided in the aromatic ring system, wherein each heteroatom is independently selected from nitrogen, oxygen, and sulfur (“5-6 membered heteroaryl”). In some embodiments, the 5-6 membered heteroaryl has 1-3 ring heteroatoms selected from nitrogen, oxygen, and sulfur. In some embodiments, the 5-6 membered heteroaryl has 1-2 ring heteroatoms selected from nitrogen, oxygen, and sulfur. In some embodiments, the 5-6 membered heteroaryl has 1 ring heteroatom selected from nitrogen, oxygen, and sulfur. Unless otherwise specified, each instance of a heteroaryl group is independently unsubstituted (an “unsubstituted heteroaryl”) or substituted (a “substituted heteroaryl”) with one or more substituents. In certain embodiments, the heteroaryl group is an unsubstituted 5-14 membered heteroaryl. In certain embodiments, the heteroaryl group is a substituted 5-14 membered heteroaryl.

Exemplary 5-membered heteroaryl groups containing 1 heteroatom include, without limitation, pyrrolyl, furanyl, and thiophenyl. Exemplary 5-membered heteroaryl groups containing 2 heteroatoms include, without limitation, imidazolyl, pyrazolyl, oxazolyl, isoxazolyl, thiazolyl, and isothiazolyl. Exemplary 5-membered heteroaryl groups containing 3 heteroatoms include, without limitation, triazolyl, oxadiazolyl, and thiadiazolyl. Exemplary 5-membered heteroaryl groups containing 4 heteroatoms include, without limitation, tetrazolyl. Exemplary 6-membered heteroaryl groups containing 1 heteroatom include, without limitation, pyridinyl. Exemplary 6-membered heteroaryl groups containing 2 heteroatoms include, without limitation, pyridazinyl, pyrimidinyl, and pyrazinyl. Exemplary 6-membered heteroaryl groups containing 3 or 4 heteroatoms include, without limitation, triazinyl and tetrazinyl, respectively. Exemplary 7-membered heteroaryl groups containing 1 heteroatom include, without limitation, azepinyl, oxepinyl, and thiepinyl. Exemplary 5,6-bicyclic heteroaryl groups include, without limitation, indolyl, isoindolyl, indazolyl, benzotriazolyl, benzothiophenyl, isobenzothiophenyl, benzofuranyl, benzoisofuranyl, benzimidazolyl, benzoxazolyl, benzisoxazolyl, benzoxadiazolyl, benzthiazolyl, benzisothiazolyl, benzthiadiazolyl, indolizinyl, and purinyl. Exemplary 6,6-bicyclic heteroaryl groups include, without limitation, naphthyridinyl, pteridinyl, quinolinyl, isoquinolinyl, cinnolinyl, quinoxalinyl, phthalazinyl, and quinazolinyl. Exemplary tricyclic heteroaryl groups include, without limitation, phenanthridinyl, dibenzofuranyl, carbazolyl, acridinyl, phenothiazinyl, phenoxazinyl, and phenazinyl.

In general, the inclusion of the prefix “alk” in front of a substituent name indicates there is an alkyl group (as defined herein) connecting the named substituent with the rest of the compound. For example, “alkaryl” (which is a subset of alkyl) refers to an alkyl group substituted by an aryl group, wherein the point of attachment is on the alkyl moiety and “alkheteroaryl” (which is a subset of “alkyl”) refers to an alkyl group substituted by a heteroaryl group, wherein the point of attachment is on the alkyl moiety. The number of carbons atoms may be specified in the alkyl chain, the named substituent, or both. For example, C₁₋₂alkC₆aryl refers to a phenyl ring (which may be substituted) connected via a 1-2 carbon alkylene group.

Affixing the suffix “-ene” to a group indicates the group is a polyvalent moiety, e.g., boned to two or more groups. Alkylene is the polyvalent moiety of alkyl, alkenylene is the divalent moiety of alkenyl, alkynylene is the divalent moiety of alkynyl, heteroalkylene is the divalent moiety of heteroalkyl, heteroalkenylene is the divalent moiety of heteroalkenyl, heteroalkynylene is the divalent moiety of heteroalkynyl, carbocyclylene is the divalent moiety of carbocyclyl, heterocyclylene is the divalent moiety of heterocyclyl, arylene is the divalent moiety of aryl, and heteroarylene is the divalent moiety of heteroaryl.

A group is optionally substituted unless expressly provided otherwise. The term “optionally substituted” refers to being substituted or unsubstituted. In certain embodiments, alkyl, alkenyl, alkynyl, heteroalkyl, heteroalkenyl, heteroalkynyl, carbocyclyl, heterocyclyl, aryl, and heteroaryl groups are optionally substituted. “Optionally substituted” refers to a group which may be substituted or unsubstituted (e.g., “substituted” or “unsubstituted” alkyl, “substituted” or “unsubstituted” alkenyl, “substituted” or “unsubstituted” alkynyl, “substituted” or “unsubstituted” heteroalkyl, “substituted” or “unsubstituted” heteroalkenyl, “substituted” or “unsubstituted” heteroalkynyl, “substituted” or “unsubstituted” carbocyclyl, “substituted” or “unsubstituted” heterocyclyl, “substituted” or “unsubstituted” aryl or “substituted” or “unsubstituted” heteroaryl group). In general, the term “substituted” means that at least one hydrogen present on a group is replaced with a permissible substituent, e.g., a substituent which upon substitution results in a stable compound, e.g., a compound which does not spontaneously undergo transformation such as by rearrangement, cyclization, elimination, or other reaction. Unless otherwise indicated, a “substituted” group has a substituent at one or more substitutable positions of the group, and when more than one position in any given structure is substituted, the substituent is either the same or different at each position. The term “substituted” is contemplated to include substitution with all permissible substituents of organic compounds and includes any of the substituents described herein that results in the formation of a stable compound. The present invention contemplates any and all such combinations in order to arrive at a stable compound. For purposes of this invention, heteroatoms such as nitrogen may have hydrogen substituents and/or any suitable substituent as described herein which satisfy the valencies of the heteroatoms and results in the formation of a stable moiety. The invention is not intended to be limited in any manner by the exemplary substituents described herein.

Exemplary carbon atom substituents include, but are not limited to, halogen, —CN, —NO₂, —N₃, —SO₂H, —SO₃H, —OH, —OR^{aa}, —ON(R^{bb})₂, —N(R^{bb})₂, —N(R^{bb})₃⁺X⁻, —N(OR^{cc})R^{bb}, —SH, —SR—, —SSR^{cc}, —C(═O)R^{aa}, —CO₂H, —CHO, —C(OR^{cc})₃, —CO₂R^{aa}, —OC(═O)R^{aa}, —OCO₂R^{aa}—, —C(═O)N(R^{bb})₂, —OC(═O)N(R^{bb})₂, —NR^{bb}C(═O)R^{aa}, —NR^{bb}CO₂R—, —NR^{bb}C(═O)N(R^{bb})₂, —C(═NR^{bb})R^{aa}, —C(═NR^{bb})OR—, —OC(═NR^{bb})R^{aa}, —OC(═NR^{bb})OR—, —C(═NR^{bb})N(R^{bb})₂, —OC(═NR^{bb})N(R^{bb})₂, —NR^{bb}C(═NR^{bb})N(R^{bb})₂, —C(═O)NR^{bb}SO₂R^{aa}, —NR^{bb}SO₂R^{aa}, —SO₂N(R^{bb})₂, —SO₂R^{aa}, —SO₂OR^{aa}, —OSO₂R^{aa}, —S(═O)R^{aa}, —OS(═O)R^{aa}, —Si(R^{aa})₃, —OSi(R^{aa})₃, —C(═S)N(R^{bb})₂, —C(═O)SR^{aa}, —C(═S)SR^{aa}, —SC(═S)SR^{aa}, —SC(═O)SR^{aa}, —OC(═O)SR^{aa}, —SC(═O)OR^{aa}, —SC(═O)R^{aa}, —P(═O)(R^{aa})₂, —P(═O)(OR^{cc})₂, —OP(═O)(R^{aa})₂, —OP(═O)(OR^{cc})₂, —P(═O)(N(R^{bb})₂)₂, —OP(═O)(N(R^{bb})₂)₂, —NR^{bb}P(═O)(R^{aa})₂, —NR^{bb}P(═O)(OR^{cc})₂, —NR^{bb}P(═O)(N(R^{bb})₂)₂, —P(R^{cc})₂, —P(OR^{cc})₂, —P(R^{cc})₃⁺X⁻, —P(OR^{cc})₃⁺X⁻, —P(R^{cc})₄, —P(OR^{cc})₂, —OP(R^{cc})₂, —OP(R^{cc})₃⁺X⁻, —OP(OR^{cc})₂, —OP(OR^{cc})₃⁺X⁻—, —OP(R^{cc})₄, —OP(OR^{cc})₄, —B(R^{aa})₂, —B(OR^{cc}C)₂, —BR^{aa}(OR^{cc}), C₁₋₁₀alkyl, C₁₋₁₀perhaloalkyl, C₂₋₁₀ alkenyl, C₂₋₁₀ alkynyl, heteroC₁₋₁₀alkyl, heteroC₂₋₁₀ alkenyl, heteroC₂₋₁₀alkynyl, C₃₋₁₀ carbocyclyl, 3-14 membered heterocyclyl, C₆₋₁₄ aryl, and 5-14 membered heteroaryl, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups; wherein X is a counterion; or two geminal hydrogens on a carbon atom are replaced with the group ═O, ═S, ═NN(R^{bb})₂, ═NNR^{bb}C(═O)R^{aa}, ═NNR^{bb}C(═O)OR^{aa}, ═NNR^{bb}S(═O)₂R^{aa}, ═NR^{bb} or ═NOR^{cc}; each instance of R^{aa} is, independently, selected from C₁₋₁₀alkyl, C₁₋₁₀perhaloalkyl, C₂₋₁₀alkenyl, C₂₋₁₀ alkynyl, heteroC₁₋₁₀alkyl, heteroC₂₋₁₀ alkenyl, heteroC₂₋₁₀alkynyl, C₃₋₁₀ carbocyclyl, 3-14 membered heterocyclyl, C₆₋₁₄aryl, and 5-14 membered heteroaryl, or two R^{aa} groups are joined to form a 3-14 membered heterocyclyl or 5-14 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups; each instance of R^{bb} is, independently, selected from hydrogen, —OH, —OR^{aa}, —N(R^{cc})₂, —CN, —C(═O)R^{aa}, —C(═O)N(R^{cc})₂, —CO₂R^{aa}, —SO₂R^{aa}, —C(═NR^{cc})OR^{aa}, —C(═NR^{cc})N(R^{cc})₂, —SO₂N(R^{cc})₂, —SO₂R^{cc}, —SO₂OR^{cc}, —SOR^{aa}, —C(═S)N(R^{cc})₂, —C(═O)SR^{cc}, —C(═S)SR^{cc}, —P(═O)(R^{aa})₂, —P(═O)(OR^{cc})₂, —P(═O)(N(R^{cc})₂)₂, C₁₋₁₀ alkyl, C₁₋₁₀perhaloalkyl, C₂₋₁₀alkenyl, C₂₋₁₀alkynyl, heteroC₁₋₁₀alkyl, heteroC₂₋₁₀alkenyl, heteroC₂₋₁₀alkynyl, C₃₋₁₀carbocyclyl, 3-14 membered heterocyclyl, C₆₋₁₄aryl, and 5-14 membered heteroaryl, or two R^{bb} groups are joined to form a 3-14 membered heterocyclyl or 5-14 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups; wherein X⁻ is a counterion; each instance of R^{cc} is, independently, selected from hydrogen, C₁₋₁₀alkyl, C₁₋₁₀perhaloalkyl, C₂₋₁₀alkenyl, C₂₋₁₀alkynyl, heteroC₁₋₁₀ alkyl, heteroC₂₋₁₀alkenyl, heteroC₂₋₁₀alkynyl, C₃₋₁₀carbocyclyl, 3-14 membered heterocyclyl, C₆₋₁₄aryl, and 5-14 membered heteroaryl, or two R^{cc} groups are joined to form a 3-14 membered heterocyclyl or 5-14 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups; each instance of R^{dd} is, independently, selected from halogen, —CN, —NO₂, —N₃, —SO₂H, —SO₃H, —OH, —OR^{ee}, —ON(R^{ff})₂, —N(R^{ff})₂, —N(R^{ff})₃⁺X⁻, —N(OR^{ee})R^{ff}, —SH, —SR^{ee}, —SSR^{ee}, —C(═O)R^{ee}, —CO₂H, —CO₂R^{ee}, —OC(═O)Re, —OCO₂R^{ee}, —C(═O)N(R^{ff})₂, —OC(═O)N(R^{ff})₂, —NR^{ff}C(═O)R^{ee}, —NR^{ff}CO₂R^{ee}, —NR^{ff}C(═O)N(R^{ff})₂, —C(═NR^{ff})OR^{ee}, —OC(═NR^{ff})R^{ee}, —OC(═NR^{ff})OR^{ee}, —C(═NR^{ff})N(R^{ff})₂, —OC(═NR^{ff})N(R^{ff})₂, —NR^{ff}C(═NR^{ff})N(R^{ff})₂, —NR^{ff}SO₂R^{ee}, —SO₂N(R^{ff})₂, —SO₂R^{ee}, —SO₂OR^{ee}, —OSO₂R^{ee}, —S(═O)R^{ee}, —Si(R^{ee})₃, —OSi(R^{ee})₃, —C(═S)N(R^{ff})₂, —C(═O)SR^{ee}, —C(═S)SR^{ee}, —SC(═S)SR^{ee}, —P(═O)(OR^{ee})₂—P(═O)(R^{ee})₂, —OP(═O)(R^{ee})₂, —OP(═O)(OR^{ee})₂, C₁₋₆ alkyl, C₁₋₆ perhaloalkyl, C₂₋₆ alkenyl, C₂₋₆ alkynyl, heteroC₁₋₆ alkyl, heteroC₂₋₆ alkenyl, heteroC₂₋₆ alkynyl, C₃₋₁₀ carbocyclyl, 3-10 membered heterocyclyl, C₆₋₁₀ aryl, 5-10 membered heteroaryl, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{gg} groups, or two geminal R^{dd} substituents can be joined to form ═O or ═S; wherein X⁻ is a counterion; each instance of R^{ee} is, independently, selected from C₁₋₆alkyl, C₁₋₆perhaloalkyl, C₂₋₆alkenyl, C₂₋₆alkynyl, heteroC₁₋₆ alkyl, heteroC₂₋₆alkenyl, heteroC₂₋₆alkynyl, C₃₋₁₀carbocyclyl, C₆₋₁₀aryl, 3-10 membered heterocyclyl, and 3-10 membered heteroaryl, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{gg} groups; each instance of R^{ff} is, independently, selected from hydrogen, C₁₋₆ alkyl, C₁₋₆ perhaloalkyl, C₂₋₆ alkenyl, C₂₋₆ alkynyl, heteroC₁₋₆ alkyl, heteroC₂₋₆ alkenyl, heteroC₂₋₆ alkynyl, C₃₋₁₀ carbocyclyl, 3-10 membered heterocyclyl, C₆₋₁₀ aryl and 5-10 membered heteroaryl, or two R^{f} groups are joined to form a 3-10 membered heterocyclyl or 5-10 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{gg} groups; and each instance of R^{gg} is, independently, halogen, —CN, —NO₂, —N₃, —SO₂H, —SO₃H, —OH, —OC₁₋₆ alkyl, —ON(C₁₋₆ alkyl)₂, —N(C₁₋₆ alkyl)₂, —N(C₁₋₆ alkyl)₃⁺X⁻, —NH(C₁₋₆ alkyl)2⁺X⁻, —NH₂(C₁₋₆ alkyl)⁺X⁻, —NH₃⁺X⁻, —N(OC₁₋₆ alkyl)(C₁₋₆ alkyl), —N(OH)(C₁₋₆ alkyl), —NH(OH), —SH, —SC₁₋₆ alkyl, —SS(C₁₋₆ alkyl), —C(═O)(C₁₋₆ alkyl), —CO₂H, —CO₂(C₁₋₆ alkyl), —OC(═O)(C₁₋₆ alkyl), —OCO₂(C₁₋₆ alkyl), —C(═O)NH₂, —C(═O)N(C₁₋₆ alkyl)₂, —OC(═O)NH(C₁₋₆ alkyl), —NHC(═O)(C₁₋₆ alkyl), —N(C₁₋₆ alkyl)C(═O)(C₁₋₆ alkyl), —NHCO₂(C₁₋₆ alkyl), —NHC(═O)N(C₁₋₆ alkyl)₂, —NHC(═O)NH(C₁₋₆ alkyl), —NHC(═O)NH₂, —C(═NH)O(C₁₋₆ alkyl), —OC(═NH)(C₁₋₆ alkyl), —OC(═NH)OC₁₋₆ alkyl, —C(═NH)N(C₁₋₆ alkyl)₂, —C(═NH)NH(C₁₋₆ alkyl), —C(═NH)NH₂, —OC(═NH)N(C₁₋₆ alkyl)₂, —OC(═NH)NH(C₁₋₆ alkyl), —OC(═NH)NH₂, —NHC(═NH)N(C₁₋₆ alkyl)₂, —NHC(═NH)NH₂, —NHSO₂(C₁₋₆ alkyl), —SO₂N(C₁₋₆ alkyl)₂, —SO₂NH(C₁₋₆ alkyl), —SO₂NH₂, —SO₂(C₁₋₆ alkyl), —SO₂O(C₁₋₆ alkyl), —OSO₂(C₁₋₆ alkyl), —SO(C₁₋₆ alkyl), —Si(C₁₋₆ alkyl)₃, —OSi(C₁₋₆ alkyl)₃, —C(═S)N(C₁₋₆ alkyl)₂, —C(═S)NH(C₁₋₆ alkyl), —C(═S)NH₂, —C(═O)S(C₁₋₆ alkyl), —C(═S)SC₁₋₆ alkyl, —SC(═S)SC₁₋₆ alkyl, —P(═O)(OC₁₋₆ alkyl)₂, —P(═O)(C₁₋₆ alkyl)₂, —OP(═O)(C₁₋₆ alkyl)₂, —OP(═O)(OC₁₋₆ alkyl)₂, C₁₋₆alkyl, C₁₋₆perhaloalkyl, C₂₋₆alkenyl, C₂₋₆alkynyl, heteroC₁₋₆alkyl, heteroC₂₋₆alkenyl, heteroC₂₋₆alkynyl, C₃₋₁₀carbocyclyl, C₆₋₁₀aryl, 3-10 membered heterocyclyl, 5-10 membered heteroaryl; or two geminal R⁹ substituents can be joined to form ═O or ═S; wherein X is a counterion.

The term “halo” or “halogen” refers to fluorine (fluoro, —F), chlorine (chloro, —Cl), bromine (bromo, —Br), or iodine (iodo, —I).

The term “acyl” refers to a group having the general formula —C(═O)R^{X1}, —C(═O)OR^{X1}, —C(═O)—O—C(═O)R^{X1}, —C(═O)SR^{X1}, —C(═O)N(R^{X1})₂, —C(═S)R^{X1}, —C(═S)N(R^{X1})₂, —C(═S)O(R^{X1}), —C(═S)S(R^{X1}), —C(═NR^{X1})R^{X1}, —C(═NR^{X1})OR^{X1}, —C(═NR^{X1})SR^{X1}, and —C(═NR^{X1})N(R^{X1})₂, wherein R^{X1} is hydrogen; halogen; substituted or unsubstituted hydroxyl; substituted or unsubstituted thiol; substituted or unsubstituted amino; substituted or unsubstituted acyl, cyclic or acyclic, substituted or unsubstituted, branched or unbranched aliphatic; cyclic or acyclic, substituted or unsubstituted, branched or unbranched heteroaliphatic; cyclic or acyclic, substituted or unsubstituted, branched or unbranched alkyl; cyclic or acyclic, substituted or unsubstituted, branched or unbranched alkenyl; substituted or unsubstituted alkynyl; substituted or unsubstituted aryl, substituted or unsubstituted heteroaryl, aliphaticoxy, heteroaliphaticoxy, alkyloxy, heteroalkyloxy, aryloxy, heteroaryloxy, aliphaticthioxy, heteroaliphaticthioxy, alkylthioxy, heteroalkylthioxy, arylthioxy, heteroarylthioxy, mono- or di-aliphaticamino, mono- or di-heteroaliphaticamino, mono- or dialkylamino, mono- or di-heteroalkylamino, mono- or di-arylamino, or mono- or diheteroarylamino; or two R^{X1} groups taken together form a 5- to 6-membered heterocyclic ring.

Exemplary acyl groups include aldehydes (—CHO), carboxylic acids (—CO₂H), ketones, acyl halides, esters, amides, imines, carbonates, carbamates, and ureas. Acyl substituents include, but are not limited to, any of the substituents described herein, that result in the formation of a stable moiety (e.g., aliphatic, alkyl, alkenyl, alkynyl, heteroaliphatic, heterocyclic, aryl, heteroaryl, acyl, oxo, imino, thiooxo, cyano, isocyano, amino, azido, nitro, hydroxyl, thiol, halo, aliphaticamino, heteroaliphaticamino, alkylamino, heteroalkylamino, arylamino, heteroarylamino, alkylaryl, arylalkyl, aliphaticoxy, heteroaliphaticoxy, alkyloxy, heteroalkyloxy, aryloxy, heteroaryloxy, aliphaticthioxy, heteroaliphaticthioxy, alkylthioxy, heteroalkylthioxy, arylthioxy, heteroarylthioxy, acyloxy, and the like, each of which may or may not be further substituted).

The term “carbonyl” refers a group wherein the carbon directly attached to the parent molecule is sp² hybridized, and is substituted with an oxygen, nitrogen or sulfur atom, e.g., a group selected from ketones (e.g., —C(═O)R^{aa}), carboxylic acids (e.g., —CO₂H), aldehydes(CHO), esters (e.g., —CO₂R^{aa}, —C(═O)SR^{aa}, —C(═S)SR^{aa}), amides (e.g., —C(═O)N(R^{bb})₂, C(═O)NR^{bb}SO₂R^{aa}, —C(═S)N(R^{bb})₂, and imines (e.g., —C(═NR^{bb})R^{aa}, —C(═NR^{bb})OR^{aa}), C(═NR^{bb})N(R^{bb})₂, wherein R^{aa} and R^{bb} are as defined herein.

The term “oxo” refers to the group ═O, and the term “thiooxo” refers to the group ═S.

The term “cyano” refers to the group —CN.

The term “azide” and “azido” refers to the group —N₃.

Nitrogen atoms can be substituted or unsubstituted as valency permits, and include primary, secondary, tertiary, and quaternary nitrogen atoms. Exemplary nitrogen atom substituents include, but are not limited to, hydrogen, —OH, —OR^{aa}, —N(R^{cc})₂, —CN, —C(═O)R^{aa}, —C(═O)N(R^{cc})₂, —CO₂R^{aa}, —SO₂R^{aa}, —C(═NR^{bb})R^{aa}, —C(═NR^{cc})OR^{aa}, —C(═NR^{cc})N(R^{cc})₂, —SO₂N(R^{cc})₂, —SO₂R^{cc}, —SO₂OR^{cc}, —SOR^{aa}, —C(═S)N(R^{cc})₂, —C(═O)SR^{cc}, —C(═S)SR^{cc}, —P(═O)(OR^{cc})₂, —P(═O)(R^{aa})₂, —P(═O)(N(R^{cc})₂)₂, C₁₋₁₀ alkyl, C₁₋₁₀ perhaloalkyl, C₂₋₁₀ alkenyl, C₂₋₁₀ alkynyl, heteroC₁₋₁₀ alkyl, heteroC₂₋₁₀ alkenyl, heteroC₂₋₁₀ alkynyl, C₃₋₁₀ carbocyclyl, 3-14 membered heterocyclyl, C₆₋₁₄ aryl, and 5-14 membered heteroaryl, or two R^{cc} groups attached to an N atom are joined to form a 3-14 membered heterocyclyl or a 5-14 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups, and wherein R^{aa}, R^{bb}, R^{cc}, and R^{dd} are as defined herein.

As used herein, the designation of a polyvalent moiety without specifying the specific order of attachment is intended to cover all possible arrangements. By way of example, a compound represented by the formula:

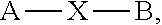

wherein X is NHC(═O) embraces both:

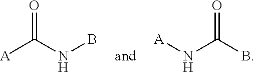

As used herein, a chemical bond depicted [symbol] represents either a single, double, or triple bond, valency permitting. By way of example,

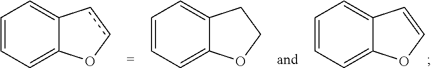

An electron-withdrawing group is a functional group or atom that pulls electron density towards itself, away from other portions of the molecule, e.g., through resonance and/or inductive effects. Exemplary electron-withdrawing groups include F, Cl, Br, I, NO₂, CN, SO₂R, SO₃R, SO₂NR₂, C(O)R^{1a}, C(O)OR, and C(O)NR₂ (wherein R is H or an alkyl, aryl, heteroaryl, cycloalkyl, heterocyclyl group) as well as alkyl group substituted with one or more of those group.

An electron-donating group is a functional group or atom that pushes electron density away from itself, towards other portions of the molecule, e.g., through resonance and/or inductive effects. Exemplary electron-donating groups include unsubstituted alkyl or aryl groups, OR and N(R)₂ and alkyl groups substituted with one or more OR and N(R)₂ groups.

Unless stated to the contrary, a formula with chemical bonds shown only as solid lines and not as wedges or dashed lines contemplates each possible isomer, e.g., each enantiomer, diastereomer, and meso compound, and a mixture of isomers, such as a racemic or scalemic mixture. Unless stated to the contrary, a formula depicting one or more stereochemical features does not exclude the presence of other isomers.

Some compounds disclosed herein may exist as one or more tautomers. Tautomers are interconvertible structural isomers that differ in the position of one or more protons or other labile atom. By way of example:

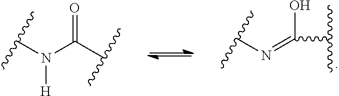

The prevalence of one tautomeric form over another will depend on the specific chemical compound as well as its local chemical environment. Unless specified to the contrary, the depiction of one tautomeric form is inclusive of all possible tautomeric forms.

Unless stated to the contrary, a substituent drawn without explicitly specifying the point of attachment indicates that the substituent may be attached at any possible atom. For example, in a benzofuran depicted as:

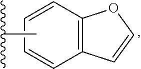

the substituent may be present at any one of the six possible carbon atoms.

As used herein, the term “null,” when referring to a possible identity of a chemical moiety, indicates that the group is absent, and the two adjacent groups are directly bonded to one another. By way of example, for a genus of compounds having the formula CH₃—X—CH₃, if X is null, then the resulting compound has the formula CH₃—CH₃.

Unless stated to the contrary, a formula with chemical bonds shown only as solid lines and not as wedges or dashed lines contemplates each possible stereoisomer or mixture of stereoisomer (e.g., each enantiomer, each diastereomer, each meso compound, a racemic mixture, or scalemic mixture).

Reference will now be made in detail to specific aspects of the disclosed materials, compounds, compositions, articles, and methods, examples of which are illustrated in the accompanying Examples and Figures.

All of the compositions and methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and methods and in the steps or in the sequence of steps of the methods described herein without departing from the concept, spirit and scope of the disclosure. More specifically, it will be apparent that certain agents which are both chemically related may be substituted for the agents described herein while the same or similar results would be achieved. All such similar substitutes and modifications apparent to those skilled in the art are deemed to be within the spirit, scope and concept of the disclosure as defined by the appended claims.

### Compounds

Provided herein are compounds defined by Formula I below

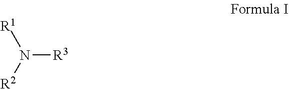

wherein
R³ is a C₁-C₆ alkyl or C₃-C₆ cycloalkyl,

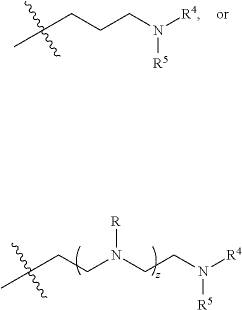

R¹, R², R⁴, R⁵, and R are independently for each occurrence, hydrogen, C₁-C₆ alkyl or C₃-C₆ cycloalkyl, —(PO)ₓ, or —(PO)ₓ(EO)_{y}, wherein at least one of R¹, R², R⁴, R⁵, or R is —(PO)ₓH, or —(PO)ₓ(EO)_{y}H;
x is an integer from 1 to 10;
y is an integer from 0-30; and
z is an integer from 0 to 10.

In some embodiments, R¹ and R² are —(PO)ₓH. In some embodiments, R³ is C₁-C₆ alkyl or C₃-C₆ cycloalkyl. In some embodiments, R¹ and R² are —(PO)ₓH and R³ is C₁-C₆ alkyl or C₃-C₆cycloalkyl.

In some embodiments, R³ is

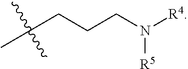

In some embodiments, R¹ and R² are C₁-C₆ alkyl. In some embodiments, R¹ and R² are methyl. In some embodiments, R¹ and R⁴ are C₁-C₆ alkyl. In some embodiments, R⁴ and R⁵ are —(PO)ₓH. In some embodiments, R² and R⁵ are —(PO)ₓH. In some embodiments, x is 2.

In some embodiments, R³ is

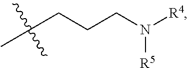

R¹ and R² are C₁-C₆ alkyl, and R⁴ and R⁵ are —(PO)ₓH. In some embodiments, R³ is

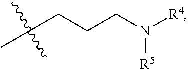

R¹ and R² are methyl, R⁴ and R⁵ are —(PO)ₓH, and x is 2.

In some embodiments, R³ is

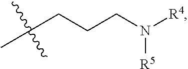

R¹ and R⁴ are C₁-C₆ alkyl, and R² and R⁵ are —(PO)ₓH. In some embodiments, R³ is

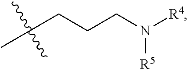

R¹ and R⁴ are methyl, R² and R⁵ are —(PO)ₓH, and x is 2.

In some embodiments, R³ is

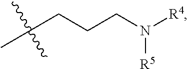

R² and R⁵ are C₁-C₆ alkyl, and R¹ and R⁴ are —(PO)ₓH. In some embodiments, R³ is

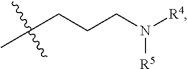

R² and R⁵ are methyl, R¹ and R⁴ are —(PO)ₓH, and x is 2.

In some embodiments, R³ is

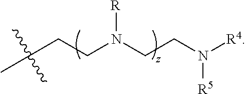

In some embodiments, z is 0, 1, 2, 3, 4, 5, 6, 7, 8, 9, or 10. In some embodiments, z is 0. In some embodiments, z is 1. In some embodiments, z is 2. In some embodiments, z is 2. In some embodiments, at least one of R¹, R², R⁴, R⁵, or R is —(PO)ₓH. In some embodiments, R⁴, R⁵, and R are —(PO)ₓH. In some embodiments, R⁴ and R⁵ are —(PO)ₓH. In some embodiments, at least one of R¹, R², R⁴, R⁵, or R is —(PO)ₓ(EO)_{y}H. In some embodiments, R⁴, R⁵, and R are —(PO)ₓ(EO)_{y}H. In some embodiments, R⁴ and R⁵ are —(PO)ₓ(EO)_{y}H. In some embodiments, R¹, R², R⁴, R⁵, and R are —(PO)ₓH. In some embodiments, R¹, R², R⁴, R⁵, and R are —(PO)ₓ(EO)_{y}H. In some embodiments, R is —(PO)ₓH. In some embodiments, R is —(PO)ₓ(EO)_{y}H. In some embodiments, R¹ is —(PO)ₓH. In some embodiments, R¹ is —(PO)ₓ(EO)_{y}H. In some embodiments, R² is —(PO)ₓH. In some embodiments, R² is —(PO)ₓ(EO)_{y}H. In some embodiments, R⁴ is —(PO)ₓH. In some embodiments, R⁴ is —(PO)ₓ(EO)_{y}H. In some embodiments, R⁵ is —(PO)ₓH. In some embodiments, R⁵ is —(PO)ₓ(EO)_{y}H.

In some embodiments, R³ is

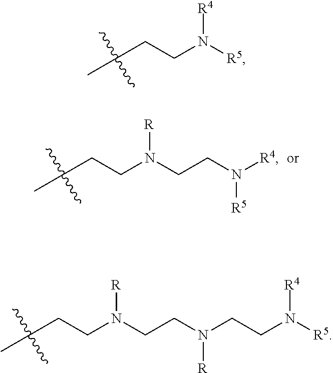

In some embodiments, the compound is selected from:

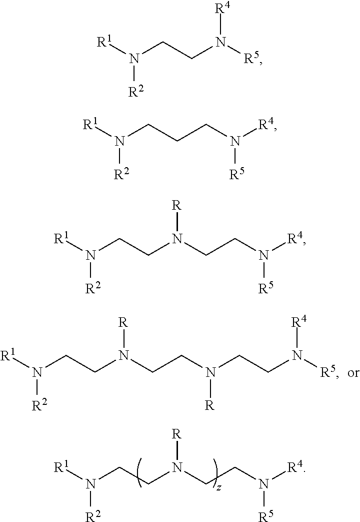

In some embodiments, the compound is selected from:

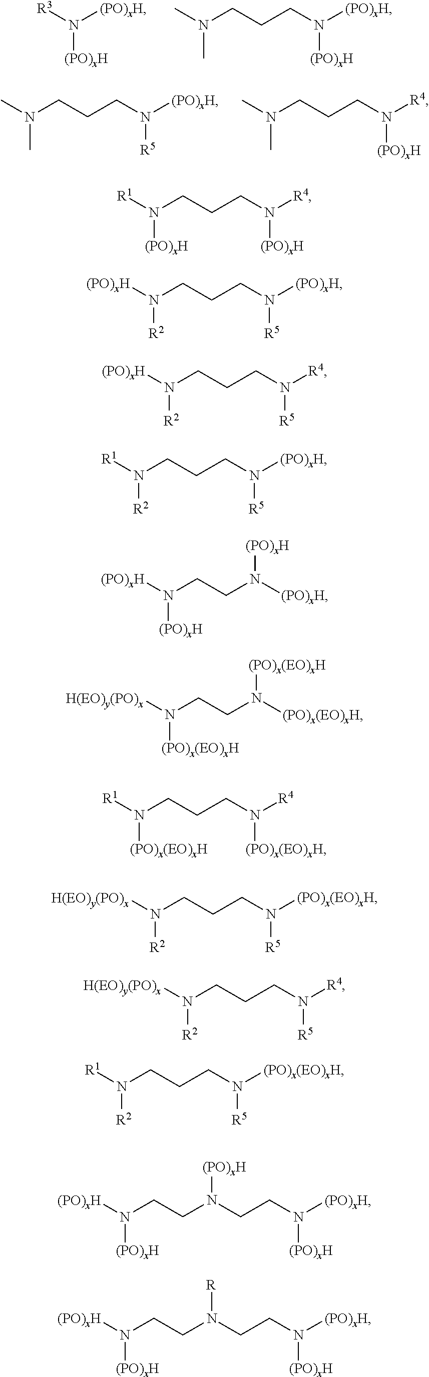

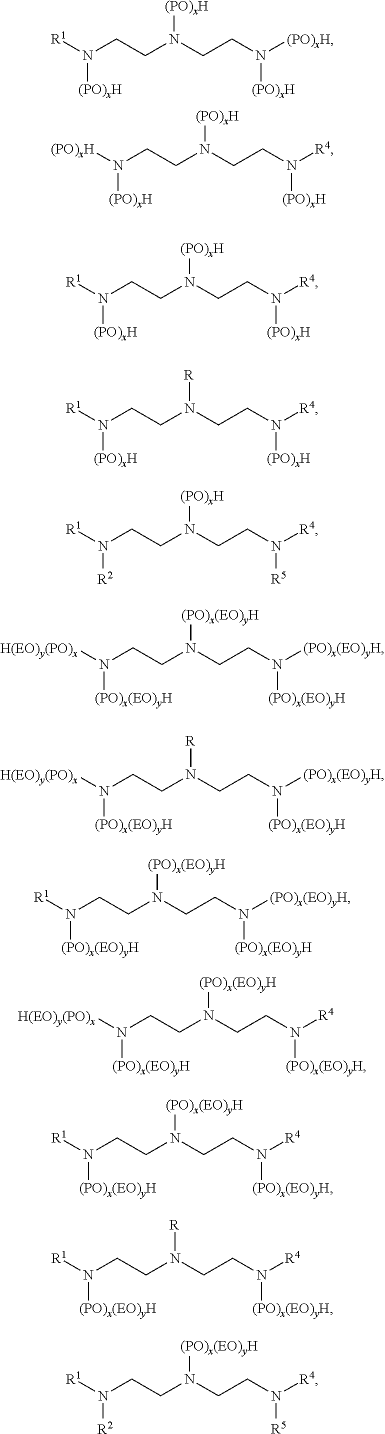

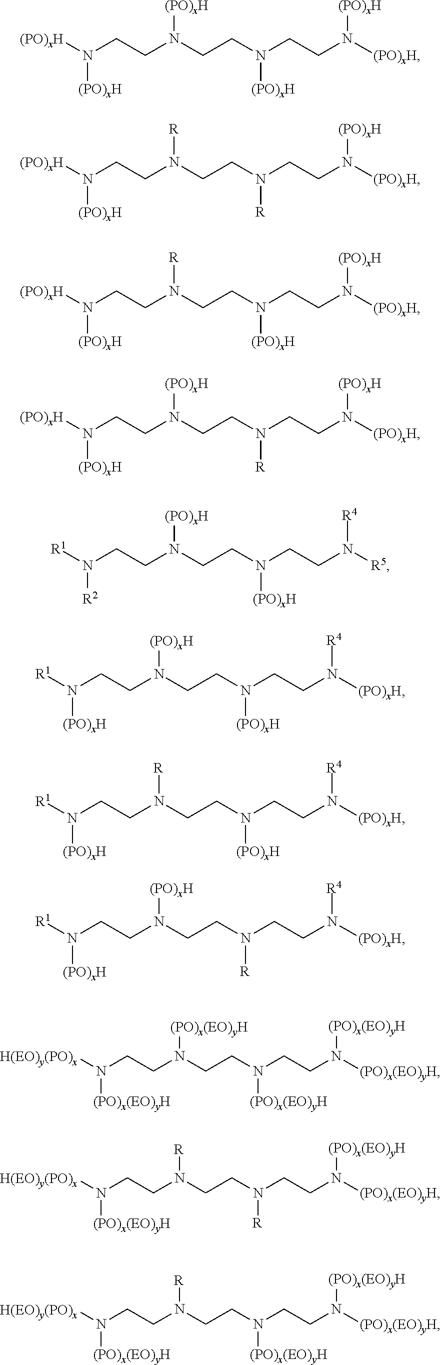

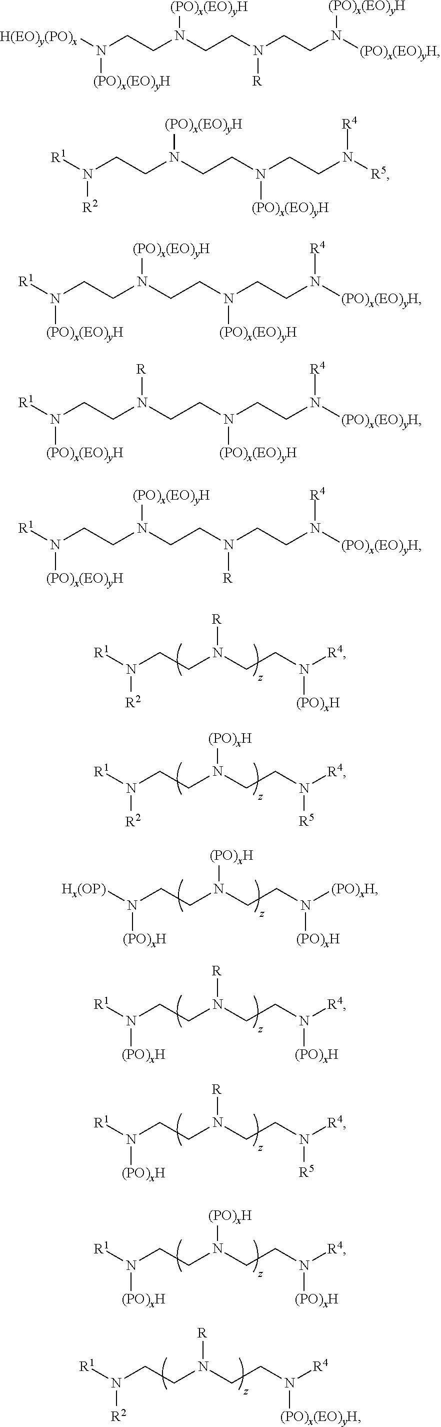

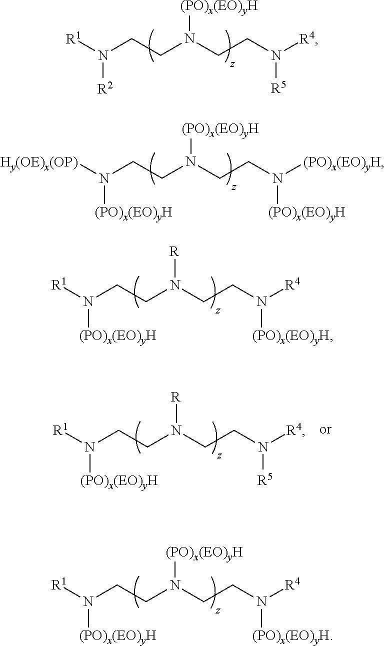

### Compositions

As described above, the compounds described herein can be used in BOR formulations to provide aqueous stability and ultra-low interfacial tension region.

Accordingly, also provided are aqueous composition for use in LOR that comprise the compounds described herein. For example, provided herein are aqueous composition that include a compound described herein and water. Additional components, including viscosity-enhancing water-soluble polymers, alkali agents, additional surfactants, co-solvents, and combinations thereof, can be present in the aqueous compositions.

In some embodiments, the aqueous composition can further comprise a surfactant. A surfactant, as used herein, is a compound within the aqueous composition that functions as a surface active agent when the aqueous composition is in contact with a crude oil (e.g., an unrefined petroleum). The surfactant can act to lower the interfacial tension and/or surface tension of the unrefined petroleum. In some embodiments, the surfactant and the compound of Formula I are present in synergistic surface active amounts. A “synergistic surface active amount,” as used herein, means that a compound of Formula I and the surfactant are present in amounts in which the oil surface activity (interfacial tension lowering effect and/or surface tension lowering effect on crude oil when the aqueous composition is added to the crude oil) of the compound and surfactant combined is greater than the additive oil surface activity of the surfactant individually and the compound individually. In some cases, the oil surface activity of the compound and surfactant combination is 10%, 20%, 30%, 40%, 50%, 60%, 70%, 80%, 90% or 100% more than the additive oil surface activity of the surfactant individually and the compound individually. In some embodiments, the oil surface activity of the compound and surfactant combination is 2, 3, 4, 5, 6, 7, 8, 9 or 10 times more than the additive oil surface activity of the surfactant individually and the compound individually.

In some embodiments, the surfactant can comprise an anionic surfactant, a non-ionic surfactant, a zwitterionic surfactant, a cationic surfactant, or a combination thereof. In some embodiments, the surfactant can comprise an anionic surfactant, a non-ionic surfactant, or a combination thereof. In some embodiments, the surfactant can comprise a plurality of anionic surfactants. In some embodiments, the surfactant can comprise a zwitterionic surfactant. “Zwitterionic” or “zwitterion” as used herein refers to a neutral molecule with a positive (or cationic) and a negative (or anionic) electrical charge at different locations within the same molecule. Examples of zwitterionic surfactants include without limitation betains and sultains.

The surfactant can be any appropriate surfactant useful in the field of enhanced oil recovery. For example, in some embodiments, the surfactant can comprise an internal olefin sulfonate (IOS), an alpha olefin sulfonate (AOS), an alkyl aryl sulfonate (ARS), an alkane sulfonate, a petroleum sulfonate, an alkyl diphenyl oxide (di)sulfonate, an alcohol sulfate, an alkoxy sulfate, an alkoxy sulfonate, an alcohol phosphate, an alkoxy phosphate, a sulfosuccinate ester, an alcohol ethoxylate, an alkyl phenol ethoxylate, a quaternary ammonium salt, a betaine or sultaine. The surfactant as provided herein, can also be a soap.

In embodiments, the surfactant can comprise an anionic surfactant. For example, the surfactant can comprise an anionic surfactant selected from the group consisting of alkoxy carboxylate surfactants, alkoxy sulfate surfactants, alkoxy sulfonate surfactants, alkyl sulfonate surfactants, aryl sulfonate surfactants, olefin sulfonate surfactants, and combinations thereof. In embodiments, the anionic surfactant can comprise an anionic surfactant blend. Where the anionic surfactant is an anionic surfactant blend, the aqueous composition includes a plurality (i.e., more than one) type of anionic surfactant.

Suitable surfactants are disclosed, for example, in U.S. Pat. Nos. 3,811,504, 3,811,505, 3,811,507, 3,890,239, 4,463,806, 6,022,843, 6,225,267, and 7,629,299; International Patent Application Publication Nos. WO/2008/079855, WO/2012/027757, WO/2016/145164, and WO/2011/094442; as well as U.S. Patent Application Publication Nos. 2005/0199395, 2006/0185845, 2006/018486, 2009/0270281, 2011/0046024, 2011/0100402, 2011/0190175, 2007/0191633, 2010/004843, 2011/0201531, 2011/0190174, 2011/0071057, 2011/0059873, 2011/0059872, 2011/0048721, 2010/0319920, 2010/0292110, and 2013/0281327, all of which are incorporated herein by reference in their entirety. Additional suitable surfactants are surfactants known to be used in enhanced oil recovery methods, including those discussed in D. B. Levitt, A. C. Jackson, L. Britton and G. A. Pope, “Identification and Evaluation of High-Performance EOR Surfactants,” SPE IX89, conference contribution for the SPE Symposium on Improved Oil Recovery Annual Meeting, Tulsa, Okla., Apr. 24-26, 2006.

A person having ordinary skill in the art will immediately recognize that many surfactants are commercially available as blends of related molecules (e.g., IOS and ABS surfactants). Thus, where a surfactant is present within a composition provided herein, a person of ordinary skill would understand that the surfactant might be a blend of a plurality of related surfactant molecules (as described herein and as generally known in the art).

In some embodiments, the total surfactant concentration (i.e., the compound of Formula I and one or more surfactants within the aqueous compositions provided herein) is from about 0.05% w/w to about 10% w/w. In other embodiments, the total suffactant concentration in the aqueous composition is from about 0.25% w/w to about 10% w/w. In other embodiments, the total surfactant concentration in the aqueous composition is about 0.5% w/w. In other embodiments, the total surfactant concentration in the aqueous composition is about 1.0% w/w. In other embodiments, the total surfactant concentration in the aqueous composition is about 1.25% w/w. In other embodiments, the total surfactant concentration in the aqueous composition is about 1.5% w/w. In other embodiments, the total surfactant concentration in the aqueous composition is about 1.75% w/w. In other embodiments, the total surfactant concentration in the aqueous composition is about 2.0% w/w. In other embodiments, the total surfactant concentration in the aqueous composition is about 2.5% w/w. In other embodiments, the total surfactant concentration in the aqueous composition is about 3.0% w/w. In other embodiments, the total surfactant concentration in the aqueous composition is about 3.5% w/w. In other embodiments, the total surfactant concentration in the aqueous composition is about 4.0% w/w. In other embodiments, the total surfactant concentration in the aqueous composition is about 4.5% w/w. In other embodiments, the total surfactant concentration in the aqueous composition is about 5.0% w/w. In other embodiments, the total surfactant concentration in the aqueous composition is about 5.5% w/w. In other embodiments, the total surfactant concentration in the aqueous composition is about 6.0% w/w. In other embodiments, the total surfactant concentration in the aqueous composition is about 6.5% w/w. In other embodiments, the total surfactant concentration in the aqueous composition is about 7.0% w/w. In other embodiments, the total surfactant concentration in the aqueous composition is about 7.5% w/w. In other embodiments, the total surfactant concentration in the aqueous composition is about 8.0% w/w. In other embodiments, the total surfactant concentration in the aqueous composition is about 9.0% w/w. In other embodiments, the total surfactant concentration in the aqueous composition is about 10% w/w.

In some embodiments, the concentration of the compound of Formula I is about 0.1%. In some further embodiments, the concentration of the surfactant is about 0.05%. In some further embodiments, the concentration of the surfactant is about 0.10%. In some further embodiments, the concentration of the surfactant is about 0.15%. In some further embodiments, the concentration of the surfactant is about 0.20%. In some further embodiments, the concentration of the surfactant is about 0.25%. In some further embodiments, the concentration of the surfactant is about 0.30%. In some further embodiments, the concentration of the surfactant is about 0.35%. In some further embodiments, the concentration of the surfactant is about 0.40%. In some further embodiments, the concentration of the surfactant is about 0.45%. In some further embodiments, the concentration of the surfactant is about 0.50%. In some further embodiments, the concentration of the surfactant is about 0.55%. In some further embodiments, the concentration of the surfactant is about 0.60%. In some further embodiments, the concentration of the surfactant is about 0.65%. In some further embodiments, the concentration of the surfactant is about 0.70%. In some further embodiments, the concentration of the surfactant is about 0.75%. In some further embodiments, the concentration of the surfactant is about 0.80%. In some further embodiments, the concentration of the surfactant is about 0.85%. In some further embodiments, the concentration of the surfactant is about 0.90%. In some further embodiments, the concentration of the surfactant is about 0.95%. In some further embodiments, the concentration of the surfactant is about 1.0%. In some further embodiments, the concentration of the surfactant is about 1.25%. In some further embodiments, the concentration of the surfactant is about 1.5%. In some further embodiments, the concentration of the surfactant is about 1.75%. In some further embodiments, the concentration of the surfactant is about 2%. In some further embodiments, the concentration of the surfactant is about 3%. In some further embodiments, the concentration of the surfactant is about 4%. In some further embodiments, the concentration of the surfactant is about 5%.

In some embodiments, the concentration of the compound of Formula I is about 0.15%. In some further embodiments, the concentration of the surfactant is about 0.05%. In some further embodiments, the concentration of the surfactant is about 0.10%. In some further embodiments, the concentration of the surfactant is about 0.15%. In some further embodiments, the concentration of the surfactant is about 0.20%. In some further embodiments, the concentration of the surfactant is about 0.25%. In some further embodiments, the concentration of the surfactant is about 0.30%. In some further embodiments, the concentration of the surfactant is about 0.35%. In some further embodiments, the concentration of the surfactant is about 0.40%. In some further embodiments, the concentration of the surfactant is about 0.45%. In some further embodiments, the concentration of the surfactant is about 0.50%. In some further embodiments, the concentration of the surfactant is about 0.55%. In some further embodiments, the concentration of the surfactant is about 0.60%. In some further embodiments, the concentration of the surfactant is about 0.65%. In some further embodiments, the concentration of the surfactant is about 0.70%. In some further embodiments, the concentration of the surfactant is about 0.75%. In some further embodiments, the concentration of the surfactant is about 0.80%. In some further embodiments, the concentration of the surfactant is about 0.85%. In some further embodiments, the concentration of the surfactant is about 0.90%. In some further embodiments, the concentration of the surfactant is about 0.95%. In some further embodiments, the concentration of the surfactant is about 1.0%. In some further embodiments, the concentration of the surfactant is about 1.25%. In some further embodiments, the concentration of the surfactant is about 1.5%. In some further embodiments, the concentration of the surfactant is about 1.75%. In some further embodiments, the concentration of the surfactant is about 2%. In some further embodiments, the concentration of the surfactant is about 3%. In some further embodiments, the concentration of the surfactant is about 4%. In some further embodiments, the concentration of the surfactant is about 5%.

In some embodiments, the concentration of the compound of Formula I is about 0.20%. In some further embodiments, the concentration of the surfactant is about 0.05%. In some further embodiments, the concentration of the surfactant is about 0.10%. In some further embodiments, the concentration of the surfactant is about 0.15%. In some further embodiments, the concentration of the surfactant is about 0.20%. In some further embodiments, the concentration of the surfactant is about 0.25%. In some further embodiments, the concentration of the surfactant is about 0.30%. In some further embodiments, the concentration of the surfactant is about 0.35%. In some further embodiments, the concentration of the surfactant is about 0.40%. In some further embodiments, the concentration of the surfactant is about 0.45%. In some further embodiments, the concentration of the surfactant is about 0.50%. In some further embodiments, the concentration of the surfactant is about 0.55%. In some further embodiments, the concentration of the surfactant is about 0.60%. In some further embodiments, the concentration of the surfactant is about 0.65%. In some further embodiments, the concentration of the surfactant is about 0.70%. In some further embodiments, the concentration of the surfactant is about 0.75%. In some further embodiments, the concentration of the surfactant is about 0.80%. In some further embodiments, the concentration of the surfactant is about 0.85%. In some further embodiments, the concentration of the surfactant is about 0.90%. In some further embodiments, the concentration of the surfactant is about 0.95%. In some further embodiments, the concentration of the surfactant is about 1.0%. In some further embodiments, the concentration of the surfactant is about 1.25%. In some further embodiments, the concentration of the surfactant is about 1.5%. In some further embodiments, the concentration of the surfactant is about 1.75%. In some further embodiments, the concentration of the surfactant is about 2%. In some further embodiments, the concentration of the surfactant is about 3%. In some further embodiments, the concentration of the surfactant is about 4%. In some further embodiments, the concentration of the surfactant is about 5%.

In some embodiments, the concentration of the compound of Formula I is about 0.25%. In some further embodiments, the concentration of the surfactant is about 0.05%. In some further embodiments, the concentration of the surfactant is about 0.10%. In some further embodiments, the concentration of the surfactant is about 0.15%. In some further embodiments, the concentration of the surfactant is about 0.20%. In some further embodiments, the concentration of the surfactant is about 0.25%. In some further embodiments, the concentration of the surfactant is about 0.30%. In some further embodiments, the concentration of the surfactant is about 0.35%. In some further embodiments, the concentration of the surfactant is about 0.40%. In some further embodiments, the concentration of the surfactant is about 0.45%. In some further embodiments, the concentration of the surfactant is about 0.50%. In some further embodiments, the concentration of the surfactant is about 0.55%. In some further embodiments, the concentration of the surfactant is about 0.60%. In some further embodiments, the concentration of the surfactant is about 0.65%. In some further embodiments, the concentration of the surfactant is about 0.70%. In some further embodiments, the concentration of the surfactant is about 0.75%. In some further embodiments, the concentration of the surfactant is about 0.80%. In some further embodiments, the concentration of the surfactant is about 0.85%. In some further embodiments, the concentration of the surfactant is about 0.90%. In some further embodiments, the concentration of the surfactant is about 0.95%. In some further embodiments, the concentration of the surfactant is about 1.0%. In some further embodiments, the concentration of the surfactant is about 1.25%. In some further embodiments, the concentration of the surfactant is about 1.5%. In some further embodiments, the concentration of the surfactant is about 1.75%. In some further embodiments, the concentration of the surfactant is about 2%. In some further embodiments, the concentration of the surfactant is about 3%. In some further embodiments, the concentration of the surfactant is about 4%. In some further embodiments, the concentration of the surfactant is about 5%.

In some embodiments, the concentration of the compound of Formula I is about 0.30%. In some further embodiments, the concentration of the surfactant is about 0.05%. In some further embodiments, the concentration of the surfactant is about 0.10%. In some further embodiments, the concentration of the surfactant is about 0.15%. In some further embodiments, the concentration of the surfactant is about 0.20%. In some further embodiments, the concentration of the surfactant is about 0.25%. In some further embodiments, the concentration of the surfactant is about 0.30%. In some further embodiments, the concentration of the surfactant is about 0.35%. In some further embodiments, the concentration of the surfactant is about 0.40%. In some further embodiments, the concentration of the surfactant is about 0.45%. In some further embodiments, the concentration of the surfactant is about 0.50%. In some further embodiments, the concentration of the surfactant is about 0.55%. In some further embodiments, the concentration of the surfactant is about 0.60%. In some further embodiments, the concentration of the surfactant is about 0.65%. In some further embodiments, the concentration of the surfactant is about 0.70%. In some further embodiments, the concentration of the surfactant is about 0.75%. In some further embodiments, the concentration of the surfactant is about 0.80%. In some further embodiments, the concentration of the surfactant is about 0.85%. In some further embodiments, the concentration of the surfactant is about 0.90%. In some further embodiments, the concentration of the surfactant is about 0.95%. In some further embodiments, the concentration of the surfactant is about 1.0%. In some further embodiments, the concentration of the surfactant is about 1.25%. In some further embodiments, the concentration of the surfactant is about 1.5%. In some further embodiments, the concentration of the surfactant is about 1.75%. In some further embodiments, the concentration of the surfactant is about 2%. In some further embodiments, the concentration of the surfactant is about 3%. In some further embodiments, the concentration of the surfactant is about 4%. In some further embodiments, the concentration of the surfactant is about 5%.

In some embodiments, the concentration of the compound of Formula I is about 0.35%. In some further embodiments, the concentration of the surfactant is about 0.05%. In some further embodiments, the concentration of the surfactant is about 0.10%. In some further embodiments, the concentration of the surfactant is about 0.15%. In some further embodiments, the concentration of the surfactant is about 0.20%. In some further embodiments, the concentration of the surfactant is about 0.25%. In some further embodiments, the concentration of the surfactant is about 0.30%. In some further embodiments, the concentration of the surfactant is about 0.35%. In some further embodiments, the concentration of the surfactant is about 0.40%. In some further embodiments, the concentration of the surfactant is about 0.45%. In some further embodiments, the concentration of the surfactant is about 0.50%. In some further embodiments, the concentration of the surfactant is about 0.55%. In some further embodiments, the concentration of the surfactant is about 0.60%. In some further embodiments, the concentration of the surfactant is about 0.65%. In some further embodiments, the concentration of the surfactant is about 0.70%. In some further embodiments, the concentration of the surfactant is about 0.75%. In some further embodiments, the concentration of the surfactant is about 0.80%. In some further embodiments, the concentration of the surfactant is about 0.85%. In some further embodiments, the concentration of the surfactant is about 0.90%. In some further embodiments, the concentration of the surfactant is about 0.95%. In some further embodiments, the concentration of the surfactant is about 1.0%. In some further embodiments, the concentration of the surfactant is about 1.25%. In some further embodiments, the concentration of the surfactant is about 1.5%. In some further embodiments, the concentration of the surfactant is about 1.75%. In some further embodiments, the concentration of the surfactant is about 2%. In some further embodiments, the concentration of the surfactant is about 3%. In some further embodiments, the concentration of the surfactant is about 4%. In some further embodiments, the concentration of the surfactant is about 5%.

In some embodiments, the concentration of the compound of Formula I is about 0.40%. In some further embodiments, the concentration of the surfactant is about 0.05%. In some further embodiments, the concentration of the surfactant is about 0.10%. In some further embodiments, the concentration of the surfactant is about 0.15%. In some further embodiments, the concentration of the surfactant is about 0.20%. In some further embodiments, the concentration of the surfactant is about 0.25%. In some further embodiments, the concentration of the surfactant is about 0.30%. In some further embodiments, the concentration of the surfactant is about 0.35%. In some further embodiments, the concentration of the surfactant is about 0.40%. In some further embodiments, the concentration of the surfactant is about 0.45%. In some further embodiments, the concentration of the surfactant is about 0.50%. In some further embodiments, the concentration of the surfactant is about 0.55%. In some further embodiments, the concentration of the surfactant is about 0.60%. In some further embodiments, the concentration of the surfactant is about 0.65%. In some further embodiments, the concentration of the surfactant is about 0.70%. In some further embodiments, the concentration of the surfactant is about 0.75%. In some further embodiments, the concentration of the surfactant is about 0.80%. In some further embodiments, the concentration of the surfactant is about 0.85%. In some further embodiments, the concentration of the surfactant is about 0.90%. In some further embodiments, the concentration of the surfactant is about 0.95%. In some further embodiments, the concentration of the surfactant is about 1.0%. In some further embodiments, the concentration of the surfactant is about 1.25%. In some further embodiments, the concentration of the surfactant is about 1.5%. In some further embodiments, the concentration of the surfactant is about 1.75%. In some further embodiments, the concentration of the surfactant is about 2%. In some further embodiments, the concentration of the surfactant is about 3%. In some further embodiments, the concentration of the surfactant is about 4%. In some further embodiments, the concentration of the surfactant is about 5%.

In some embodiments, the concentration of the compound of Formula I is about 0.45%. In some further embodiments, the concentration of the surfactant is about 0.05%. In some further embodiments, the concentration of the surfactant is about 0.10%. In some further embodiments, the concentration of the surfactant is about 0.15%. In some further embodiments, the concentration of the surfactant is about 0.20%. In some further embodiments, the concentration of the surfactant is about 0.25%. In some further embodiments, the concentration of the surfactant is about 0.30%. In some further embodiments, the concentration of the surfactant is about 0.35%. In some further embodiments, the concentration of the surfactant is about 0.40%. In some further embodiments, the concentration of the surfactant is about 0.45%. In some further embodiments, the concentration of the surfactant is about 0.50%. In some further embodiments, the concentration of the surfactant is about 0.55%. In some further embodiments, the concentration of the surfactant is about 0.60%. In some further embodiments, the concentration of the surfactant is about 0.65%. In some further embodiments, the concentration of the surfactant is about 0.70%. In some further embodiments, the concentration of the surfactant is about 0.75%. In some further embodiments, the concentration of the surfactant is about 0.80%. In some further embodiments, the concentration of the surfactant is about 0.85%. In some further embodiments, the concentration of the surfactant is about 0.90%. In some further embodiments, the concentration of the surfactant is about 0.95%. In some further embodiments, the concentration of the surfactant is about 1.0%. In some further embodiments, the concentration of the surfactant is about 1.25%. In some further embodiments, the concentration of the surfactant is about 1.5%. In some further embodiments, the concentration of the surfactant is about 1.75%. In some further embodiments, the concentration of the surfactant is about 2%. In some further embodiments, the concentration of the surfactant is about 3%. In some further embodiments, the concentration of the surfactant is about 4%. In some further embodiments, the concentration of the surfactant is about 5%.

In some embodiments, the concentration of the compound of Formula I is about 0.50%. In some further embodiments, the concentration of the surfactant is about 0.05%. In some further embodiments, the concentration of the surfactant is about 0.10%. In some further embodiments, the concentration of the surfactant is about 0.15%. In some further embodiments, the concentration of the surfactant is about 0.20%. In some further embodiments, the concentration of the surfactant is about 0.25%. In some further embodiments, the concentration of the surfactant is about 0.30%. In some further embodiments, the concentration of the surfactant is about 0.35%. In some further embodiments, the concentration of the surfactant is about 0.40%. In some further embodiments, the concentration of the surfactant is about 0.45%. In some further embodiments, the concentration of the surfactant is about 0.50%. In some further embodiments, the concentration of the surfactant is about 0.55%. In some further embodiments, the concentration of the surfactant is about 0.60%. In some further embodiments, the concentration of the surfactant is about 0.65%. In some further embodiments, the concentration of the surfactant is about 0.70%. In some further embodiments, the concentration of the surfactant is about 0.75%. In some further embodiments, the concentration of the surfactant is about 0.80%. In some further embodiments, the concentration of the surfactant is about 0.85%. In some further embodiments, the concentration of the surfactant is about 0.90%. In some further embodiments, the concentration of the surfactant is about 0.95%. In some further embodiments, the concentration of the surfactant is about 1.0%. In some further embodiments, the concentration of the surfactant is about 1.25%. In some further embodiments, the concentration of the surfactant is about 1.5%. In some further embodiments, the concentration of the surfactant is about 1.75%. In some further embodiments, the concentration of the surfactant is about 2%. In some further embodiments, the concentration of the surfactant is about 3%. In some further embodiments, the concentration of the surfactant is about 4%. In some further embodiments, the concentration of the surfactant is about 5%.

In some embodiments, the concentration of the compound of Formula I is about 0.55%. In some further embodiments, the concentration of the surfactant is about 0.05%. In some further embodiments, the concentration of the surfactant is about 0.10%. In some further embodiments, the concentration of the surfactant is about 0.15%. In some further embodiments, the concentration of the surfactant is about 0.20%. In some further embodiments, the concentration of the surfactant is about 0.25%. In some further embodiments, the concentration of the surfactant is about 0.30%. In some further embodiments, the concentration of the surfactant is about 0.35%. In some further embodiments, the concentration of the surfactant is about 0.40%. In some further embodiments, the concentration of the surfactant is about 0.45%. In some further embodiments, the concentration of the surfactant is about 0.50%. In some further embodiments, the concentration of the surfactant is about 0.55%. In some further embodiments, the concentration of the surfactant is about 0.60%. In some further embodiments, the concentration of the surfactant is about 0.65%. In some further embodiments, the concentration of the surfactant is about 0.70%. In some further embodiments, the concentration of the surfactant is about 0.75%. In some further embodiments, the concentration of the surfactant is about 0.80%. In some further embodiments, the concentration of the surfactant is about 0.85%. In some further embodiments, the concentration of the surfactant is about 0.90%. In some further embodiments, the concentration of the surfactant is about 0.95%. In some further embodiments, the concentration of the surfactant is about 1.0%. In some further embodiments, the concentration of the surfactant is about 1.25%. In some further embodiments, the concentration of the surfactant is about 1.5%. In some further embodiments, the concentration of the surfactant is about 1.75%. In some further embodiments, the concentration of the surfactant is about 2%. In some further embodiments, the concentration of the surfactant is about 3%. In some further embodiments, the concentration of the surfactant is about 4%. In some further embodiments, the concentration of the surfactant is about 5%.

In some embodiments, the concentration of the compound of Formula I is about 0.60%. In some further embodiments, the concentration of the surfactant is about 0.05%. In some further embodiments, the concentration of the surfactant is about 0.10%. In some further embodiments, the concentration of the surfactant is about 0.15%. In some further embodiments, the concentration of the surfactant is about 0.20%. In some further embodiments, the concentration of the surfactant is about 0.25%. In some further embodiments, the concentration of the surfactant is about 0.30%. In some further embodiments, the concentration of the surfactant is about 0.35%. In some further embodiments, the concentration of the surfactant is about 0.40%. In some further embodiments, the concentration of the surfactant is about 0.45%. In some further embodiments, the concentration of the surfactant is about 0.50%. In some further embodiments, the concentration of the surfactant is about 0.55%. In some further embodiments, the concentration of the surfactant is about 0.60%. In some further embodiments, the concentration of the surfactant is about 0.65%. In some further embodiments, the concentration of the surfactant is about 0.70%. In some further embodiments, the concentration of the surfactant is about 0.75%. In some further embodiments, the concentration of the surfactant is about 0.80%. In some further embodiments, the concentration of the surfactant is about 0.85%. In some further embodiments, the concentration of the surfactant is about 0.90%. In some further embodiments, the concentration of the surfactant is about 0.95%. In some further embodiments, the concentration of the surfactant is about 1.0%. In some further embodiments, the concentration of the surfactant is about 1.25%. In some further embodiments, the concentration of the surfactant is about 1.5%. In some further embodiments, the concentration of the surfactant is about 1.75%. In some further embodiments, the concentration of the surfactant is about 2%. In some further embodiments, the concentration of the surfactant is about 3%. In some further embodiments, the concentration of the surfactant is about 4%. In some further embodiments, the concentration of the surfactant is about 5%.

In some embodiments, the concentration of the compound of Formula I is about 0.65%. In some further embodiments, the concentration of the surfactant is about 0.05%. In some further embodiments, the concentration of the surfactant is about 0.10%. In some further embodiments, the concentration of the surfactant is about 0.15%. In some further embodiments, the concentration of the surfactant is about 0.20%. In some further embodiments, the concentration of the surfactant is about 0.25%. In some further embodiments, the concentration of the surfactant is about 0.30%. In some further embodiments, the concentration of the surfactant is about 0.35%. In some further embodiments, the concentration of the surfactant is about 0.40%. In some further embodiments, the concentration of the surfactant is about 0.45%. In some further embodiments, the concentration of the surfactant is about 0.50%. In some further embodiments, the concentration of the surfactant is about 0.55%. In some further embodiments, the concentration of the surfactant is about 0.60%. In some further embodiments, the concentration of the surfactant is about 0.65%. In some further embodiments, the concentration of the surfactant is about 0.70%. In some further embodiments, the concentration of the surfactant is about 0.75%. In some further embodiments, the concentration of the surfactant is about 0.80%. In some further embodiments, the concentration of the surfactant is about 0.85%. In some further embodiments, the concentration of the surfactant is about 0.90%. In some further embodiments, the concentration of the surfactant is about 0.95%. In some further embodiments, the concentration of the surfactant is about 1.0%. In some further embodiments, the concentration of the surfactant is about 1.25%. In some further embodiments, the concentration of the surfactant is about 1.5%. In some further embodiments, the concentration of the surfactant is about 1.75%. In some further embodiments, the concentration of the surfactant is about 2%. In some further embodiments, the concentration of the surfactant is about 3%. In some further embodiments, the concentration of the surfactant is about 4%. In some further embodiments, the concentration of the surfactant is about 5%.

In some embodiments, the concentration of the compound of Formula I is about 0.70%. In some further embodiments, the concentration of the surfactant is about 0.05%. In some further embodiments, the concentration of the surfactant is about 0.10%. In some further embodiments, the concentration of the surfactant is about 0.15%. In some further embodiments, the concentration of the surfactant is about 0.20%. In some further embodiments, the concentration of the surfactant is about 0.25%. In some further embodiments, the concentration of the surfactant is about 0.30%. In some further embodiments, the concentration of the surfactant is about 0.35%. In some further embodiments, the concentration of the surfactant is about 0.40%. In some further embodiments, the concentration of the surfactant is about 0.45%. In some further embodiments, the concentration of the surfactant is about 0.50%. In some further embodiments, the concentration of the surfactant is about 0.55%. In some further embodiments, the concentration of the surfactant is about 0.60%. In some further embodiments, the concentration of the surfactant is about 0.65%. In some further embodiments, the concentration of the surfactant is about 0.70%. In some further embodiments, the concentration of the surfactant is about 0.75%. In some further embodiments, the concentration of the surfactant is about 0.80%. In some further embodiments, the concentration of the surfactant is about 0.85%. In some further embodiments, the concentration of the surfactant is about 0.90%. In some further embodiments, the concentration of the surfactant is about 0.95%. In some further embodiments, the concentration of the surfactant is about 1.0%. In some further embodiments, the concentration of the surfactant is about 1.25%. In some further embodiments, the concentration of the surfactant is about 1.5%. In some further embodiments, the concentration of the surfactant is about 1.75%. In some further embodiments, the concentration of the surfactant is about 2%. In some further embodiments, the concentration of the surfactant is about 3%. In some further embodiments, the concentration of the surfactant is about 4%. In some further embodiments, the concentration of the surfactant is about 5%.

In some embodiments, the concentration of the compound of Formula I is about 0.75%. In some further embodiments, the concentration of the surfactant is about 0.05%. In some further embodiments, the concentration of the surfactant is about 0.10%. In some further embodiments, the concentration of the surfactant is about 0.15%. In some further embodiments, the concentration of the surfactant is about 0.20%. In some further embodiments, the concentration of the surfactant is about 0.25%. In some further embodiments, the concentration of the surfactant is about 0.30%. In some further embodiments, the concentration of the surfactant is about 0.35%. In some further embodiments, the concentration of the surfactant is about 0.40%. In some further embodiments, the concentration of the surfactant is about 0.45%. In some further embodiments, the concentration of the surfactant is about 0.50%. In some further embodiments, the concentration of the surfactant is about 0.55%. In some further embodiments, the concentration of the surfactant is about 0.60%. In some further embodiments, the concentration of the surfactant is about 0.65%. In some further embodiments, the concentration of the surfactant is about 0.70%. In some further embodiments, the concentration of the surfactant is about 0.75%. In some further embodiments, the concentration of the surfactant is about 0.80%. In some further embodiments, the concentration of the surfactant is about 0.85%. In some further embodiments, the concentration of the surfactant is about 0.90%. In some further embodiments, the concentration of the surfactant is about 0.95%. In some further embodiments, the concentration of the surfactant is about 1.0%. In some further embodiments, the concentration of the surfactant is about 1.25%. In some further embodiments, the concentration of the surfactant is about 1.5%. In some further embodiments, the concentration of the surfactant is about 1.75%. In some further embodiments, the concentration of the surfactant is about 2%. In some further embodiments, the concentration of the surfactant is about 3%. In some further embodiments, the concentration of the surfactant is about 4%. In some further embodiments, the concentration of the surfactant is about 5%.

In some embodiments, the concentration of the compound of Formula I is about 0.80%. In some further embodiments, the concentration of the surfactant is about 0.05%. In some further embodiments, the concentration of the surfactant is about 0.10%. In some further embodiments, the concentration of the surfactant is about 0.15%. In some further embodiments, the concentration of the surfactant is about 0.20%. In some further embodiments, the concentration of the surfactant is about 0.25%. In some further embodiments, the concentration of the surfactant is about 0.30%. In some further embodiments, the concentration of the surfactant is about 0.35%. In some further embodiments, the concentration of the surfactant is about 0.40%. In some further embodiments, the concentration of the surfactant is about 0.45%. In some further embodiments, the concentration of the surfactant is about 0.50%. In some further embodiments, the concentration of the surfactant is about 0.55%. In some further embodiments, the concentration of the surfactant is about 0.60%. In some further embodiments, the concentration of the surfactant is about 0.65%. In some further embodiments, the concentration of the surfactant is about 0.70%. In some further embodiments, the concentration of the surfactant is about 0.75%. In some further embodiments, the concentration of the surfactant is about 0.80%. In some further embodiments, the concentration of the surfactant is about 0.85%. In some further embodiments, the concentration of the surfactant is about 0.90%. In some further embodiments, the concentration of the surfactant is about 0.95%. In some further embodiments, the concentration of the surfactant is about 1.0%. In some further embodiments, the concentration of the surfactant is about 1.25%. In some further embodiments, the concentration of the surfactant is about 1.5%. In some further embodiments, the concentration of the surfactant is about 1.75%. In some further embodiments, the concentration of the surfactant is about 2%. In some further embodiments, the concentration of the surfactant is about 3%. In some further embodiments, the concentration of the surfactant is about 4%. In some further embodiments, the concentration of the surfactant is about 5%.

In some embodiments, the concentration of the compound of Formula I is about 0.85%. In some further embodiments, the concentration of the surfactant is about 0.05%. In some further embodiments, the concentration of the surfactant is about 0.10%. In some further embodiments, the concentration of the surfactant is about 0.15%. In some further embodiments, the concentration of the surfactant is about 0.20%. In some further embodiments, the concentration of the surfactant is about 0.25%. In some further embodiments, the concentration of the surfactant is about 0.30%. In some further embodiments, the concentration of the surfactant is about 0.35%. In some further embodiments, the concentration of the surfactant is about 0.40%. In some further embodiments, the concentration of the surfactant is about 0.45%. In some further embodiments, the concentration of the surfactant is about 0.50%. In some further embodiments, the concentration of the surfactant is about 0.55%. In some further embodiments, the concentration of the surfactant is about 0.60%. In some further embodiments, the concentration of the surfactant is about 0.65%. In some further embodiments, the concentration of the surfactant is about 0.70%. In some further embodiments, the concentration of the surfactant is about 0.75%. In some further embodiments, the concentration of the surfactant is about 0.80%. In some further embodiments, the concentration of the surfactant is about 0.85%. In some further embodiments, the concentration of the surfactant is about 0.90%. In some further embodiments, the concentration of the surfactant is about 0.95%. In some further embodiments, the concentration of the surfactant is about 1.0%. In some further embodiments, the concentration of the surfactant is about 1.25%. In some further embodiments, the concentration of the surfactant is about 1.5%. In some further embodiments, the concentration of the surfactant is about 1.75%. In some further embodiments, the concentration of the surfactant is about 2%. In some further embodiments, the concentration of the surfactant is about 3%. In some further embodiments, the concentration of the surfactant is about 4%. In some further embodiments, the concentration of the surfactant is about 5%.

In some embodiments, the concentration of the compound of Formula I is about 0.90%. In some further embodiments, the concentration of the surfactant is about 0.05%. In some further embodiments, the concentration of the surfactant is about 0.10%. In some further embodiments, the concentration of the surfactant is about 0.15%. In some further embodiments, the concentration of the surfactant is about 0.20%. In some further embodiments, the concentration of the surfactant is about 0.25%. In some further embodiments, the concentration of the surfactant is about 0.30%. In some further embodiments, the concentration of the surfactant is about 0.35%. In some further embodiments, the concentration of the surfactant is about 0.40%. In some further embodiments, the concentration of the surfactant is about 0.45%. In some further embodiments, the concentration of the surfactant is about 0.50%. In some further embodiments, the concentration of the surfactant is about 0.55%. In some further embodiments, the concentration of the surfactant is about 0.60%. In some further embodiments, the concentration of the surfactant is about 0.65%. In some further embodiments, the concentration of the surfactant is about 0.70%. In some further embodiments, the concentration of the surfactant is about 0.75%. In some further embodiments, the concentration of the surfactant is about 0.80%. In some further embodiments, the concentration of the surfactant is about 0.85%. In some further embodiments, the concentration of the surfactant is about 0.90%. In some further embodiments, the concentration of the surfactant is about 0.95%. In some further embodiments, the concentration of the surfactant is about 1.0%. In some further embodiments, the concentration of the surfactant is about 1.25%. In some further embodiments, the concentration of the surfactant is about 1.5%. In some further embodiments, the concentration of the surfactant is about 1.75%. In some further embodiments, the concentration of the surfactant is about 2%. In some further embodiments, the concentration of the surfactant is about 3%. In some further embodiments, the concentration of the surfactant is about 4%. In some further embodiments, the concentration of the surfactant is about 5%.

In some embodiments, the concentration of the compound of Formula I is about 0.95%. In some further embodiments, the concentration of the surfactant is about 0.05%. In some further embodiments, the concentration of the surfactant is about 0.10%. In some further embodiments, the concentration of the surfactant is about 0.15%. In some further embodiments, the concentration of the surfactant is about 0.20%. In some further embodiments, the concentration of the surfactant is about 0.25%. In some further embodiments, the concentration of the surfactant is about 0.30%. In some further embodiments, the concentration of the surfactant is about 0.35%. In some further embodiments, the concentration of the surfactant is about 0.40%. In some further embodiments, the concentration of the surfactant is about 0.45%. In some further embodiments, the concentration of the surfactant is about 0.50%. In some further embodiments, the concentration of the surfactant is about 0.55%. In some further embodiments, the concentration of the surfactant is about 0.60%. In some further embodiments, the concentration of the surfactant is about 0.65%. In some further embodiments, the concentration of the surfactant is about 0.70%. In some further embodiments, the concentration of the surfactant is about 0.75%. In some further embodiments, the concentration of the surfactant is about 0.80%. In some further embodiments, the concentration of the surfactant is about 0.85%. In some further embodiments, the concentration of the surfactant is about 0.90%. In some further embodiments, the concentration of the surfactant is about 0.95%. In some further embodiments, the concentration of the surfactant is about 1.0%. In some further embodiments, the concentration of the surfactant is about 1.25%. In some further embodiments, the concentration of the surfactant is about 1.5%. In some further embodiments, the concentration of the surfactant is about 1.75%. In some further embodiments, the concentration of the surfactant is about 2%. In some further embodiments, the concentration of the surfactant is about 3%. In some further embodiments, the concentration of the surfactant is about 4%. In some further embodiments, the concentration of the surfactant is about 5%.

In some embodiments, the concentration of the compound of Formula I is about 1.0%. In some further embodiments, the concentration of the surfactant is about 0.05%. In some further embodiments, the concentration of the surfactant is about 0.10%. In some further embodiments, the concentration of the surfactant is about 0.15%. In some further embodiments, the concentration of the surfactant is about 0.20%. In some further embodiments, the concentration of the surfactant is about 0.25%. In some further embodiments, the concentration of the surfactant is about 0.30%. In some further embodiments, the concentration of the surfactant is about 0.35%. In some further embodiments, the concentration of the surfactant is about 0.40%. In some further embodiments, the concentration of the surfactant is about 0.45%. In some further embodiments, the concentration of the surfactant is about 0.50%. In some further embodiments, the concentration of the surfactant is about 0.55%. In some further embodiments, the concentration of the surfactant is about 0.60%. In some further embodiments, the concentration of the surfactant is about 0.65%. In some further embodiments, the concentration of the surfactant is about 0.70%. In some further embodiments, the concentration of the surfactant is about 0.75%. In some further embodiments, the concentration of the surfactant is about 0.80%. In some further embodiments, the concentration of the surfactant is about 0.85%. In some further embodiments, the concentration of the surfactant is about 0.90%. In some further embodiments, the concentration of the surfactant is about 0.95%. In some further embodiments, the concentration of the surfactant is about 1.0%. In some further embodiments, the concentration of the surfactant is about 1.25%. In some further embodiments, the concentration of the surfactant is about 1.5%. In some further embodiments, the concentration of the surfactant is about 1.75%. In some further embodiments, the concentration of the surfactant is about 2%. In some further embodiments, the concentration of the surfactant is about 3%. In some further embodiments, the concentration of the surfactant is about 4%. In some further embodiments, the concentration of the surfactant is about 5%.

In some embodiments, the concentration of the compound of Formula I is about 1.25%. In some further embodiments, the concentration of the surfactant is about 0.05%. In some further embodiments, the concentration of the surfactant is about 0.10%. In some further embodiments, the concentration of the surfactant is about 0.15%. In some further embodiments, the concentration of the surfactant is about 0.20%. In some further embodiments, the concentration of the surfactant is about 0.25%. In some further embodiments, the concentration of the surfactant is about 0.30%. In some further embodiments, the concentration of the surfactant is about 0.35%. In some further embodiments, the concentration of the surfactant is about 0.40%. In some further embodiments, the concentration of the surfactant is about 0.45%. In some further embodiments, the concentration of the surfactant is about 0.50%. In some further embodiments, the concentration of the surfactant is about 0.55%. In some further embodiments, the concentration of the surfactant is about 0.60%. In some further embodiments, the concentration of the surfactant is about 0.65%. In some further embodiments, the concentration of the surfactant is about 0.70%. In some further embodiments, the concentration of the surfactant is about 0.75%. In some further embodiments, the concentration of the surfactant is about 0.80%. In some further embodiments, the concentration of the surfactant is about 0.85%. In some further embodiments, the concentration of the surfactant is about 0.90%. In some further embodiments, the concentration of the surfactant is about 0.95%. In some further embodiments, the concentration of the surfactant is about 1.0%. In some further embodiments, the concentration of the surfactant is about 1.25%. In some further embodiments, the concentration of the surfactant is about 1.5%. In some further embodiments, the concentration of the surfactant is about 1.75%. In some further embodiments, the concentration of the surfactant is about 2%. In some further embodiments, the concentration of the surfactant is about 3%. In some further embodiments, the concentration of the surfactant is about 4%. In some further embodiments, the concentration of the surfactant is about 5%.

In some embodiments, the concentration of the compound of Formula I is about 1.50%. In some further embodiments, the concentration of the surfactant is about 0.05%. In some further embodiments, the concentration of the surfactant is about 0.10%. In some further embodiments, the concentration of the surfactant is about 0.15%. In some further embodiments, the concentration of the surfactant is about 0.20%. In some further embodiments, the concentration of the surfactant is about 0.25%. In some further embodiments, the concentration of the surfactant is about 0.30%. In some further embodiments, the concentration of the surfactant is about 0.35%. In some further embodiments, the concentration of the surfactant is about 0.40%. In some further embodiments, the concentration of the surfactant is about 0.45%. In some further embodiments, the concentration of the surfactant is about 0.50%. In some further embodiments, the concentration of the surfactant is about 0.55%. In some further embodiments, the concentration of the surfactant is about 0.60%. In some further embodiments, the concentration of the surfactant is about 0.65%. In some further embodiments, the concentration of the surfactant is about 0.70%. In some further embodiments, the concentration of the surfactant is about 0.75%. In some further embodiments, the concentration of the surfactant is about 0.80%. In some further embodiments, the concentration of the surfactant is about 0.85%. In some further embodiments, the concentration of the surfactant is about 0.90%. In some further embodiments, the concentration of the surfactant is about 0.95%. In some further embodiments, the concentration of the surfactant is about 1.0%. In some further embodiments, the concentration of the surfactant is about 1.25%. In some further embodiments, the concentration of the surfactant is about 1.5%. In some further embodiments, the concentration of the surfactant is about 1.75%. In some further embodiments, the concentration of the surfactant is about 2%. In some further embodiments, the concentration of the surfactant is about 3%. In some further embodiments, the concentration of the surfactant is about 4%. In some further embodiments, the concentration of the surfactant is about 5%.

In some embodiments, the concentration of the compound of Formula I is about 1.75%. In some further embodiments, the concentration of the surfactant is about 0.05%. In some further embodiments, the concentration of the surfactant is about 0.10%. In some further embodiments, the concentration of the surfactant is about 0.15%. In some further embodiments, the concentration of the surfactant is about 0.20%. In some further embodiments, the concentration of the surfactant is about 0.25%. In some further embodiments, the concentration of the surfactant is about 0.30%. In some further embodiments, the concentration of the surfactant is about 0.35%. In some further embodiments, the concentration of the surfactant is about 0.40%. In some further embodiments, the concentration of the surfactant is about 0.45%. In some further embodiments, the concentration of the surfactant is about 0.50%. In some further embodiments, the concentration of the surfactant is about 0.55%. In some further embodiments, the concentration of the surfactant is about 0.60%. In some further embodiments, the concentration of the surfactant is about 0.65%. In some further embodiments, the concentration of the surfactant is about 0.70%. In some further embodiments, the concentration of the surfactant is about 0.75%. In some further embodiments, the concentration of the surfactant is about 0.80%. In some further embodiments, the concentration of the surfactant is about 0.85%. In some further embodiments, the concentration of the surfactant is about 0.90%. In some further embodiments, the concentration of the surfactant is about 0.95%. In some further embodiments, the concentration of the surfactant is about 1.0%. In some further embodiments, the concentration of the surfactant is about 1.25%. In some further embodiments, the concentration of the surfactant is about 1.5%. In some further embodiments, the concentration of the surfactant is about 1.75%. In some further embodiments, the concentration of the surfactant is about 2%. In some further embodiments, the concentration of the surfactant is about 3%. In some further embodiments, the concentration of the surfactant is about 4%. In some further embodiments, the concentration of the surfactant is about 5%.

In some embodiments, the concentration of the compound of Formula I is about 2%. In some further embodiments, the concentration of the surfactant is about 0.05%. In some further embodiments, the concentration of the surfactant is about 0.10%. In some further embodiments, the concentration of the surfactant is about 0.15%. In some further embodiments, the concentration of the surfactant is about 0.20%. In some further embodiments, the concentration of the surfactant is about 0.25%. In some further embodiments, the concentration of the surfactant is about 0.30%. In some further embodiments, the concentration of the surfactant is about 0.35%. In some further embodiments, the concentration of the surfactant is about 0.40%. In some further embodiments, the concentration of the surfactant is about 0.45%. In some further embodiments, the concentration of the surfactant is about 0.50%. In some further embodiments, the concentration of the surfactant is about 0.55%. In some further embodiments, the concentration of the surfactant is about 0.60%. In some further embodiments, the concentration of the surfactant is about 0.65%. In some further embodiments, the concentration of the surfactant is about 0.70%. In some further embodiments, the concentration of the surfactant is about 0.75%. In some further embodiments, the concentration of the surfactant is about 0.80%. In some further embodiments, the concentration of the surfactant is about 0.85%. In some further embodiments, the concentration of the surfactant is about 0.90%. In some further embodiments, the concentration of the surfactant is about 0.95%. In some further embodiments, the concentration of the surfactant is about 1.0%. In some further embodiments, the concentration of the surfactant is about 1.25%. In some further embodiments, the concentration of the surfactant is about 1.5%. In some further embodiments, the concentration of the surfactant is about 1.75%. In some further embodiments, the concentration of the surfactant is about 2%. In some further embodiments, the concentration of the surfactant is about 3%. In some further embodiments, the concentration of the surfactant is about 4%. In some further embodiments, the concentration of the surfactant is about 5%.

In some embodiments, the concentration of the compound of Formula I is about 3%. In some further embodiments, the concentration of the surfactant is about 0.05%. In some further embodiments, the concentration of the surfactant is about 0.10%. In some further embodiments, the concentration of the surfactant is about 0.15%. In some further embodiments, the concentration of the surfactant is about 0.20%. In some further embodiments, the concentration of the surfactant is about 0.25%. In some further embodiments, the concentration of the surfactant is about 0.30%. In some further embodiments, the concentration of the surfactant is about 0.35%. In some further embodiments, the concentration of the surfactant is about 0.40%. In some further embodiments, the concentration of the surfactant is about 0.45%. In some further embodiments, the concentration of the surfactant is about 0.50%. In some further embodiments, the concentration of the surfactant is about 0.55%. In some further embodiments, the concentration of the surfactant is about 0.60%. In some further embodiments, the concentration of the surfactant is about 0.65%. In some further embodiments, the concentration of the surfactant is about 0.70%. In some further embodiments, the concentration of the surfactant is about 0.75%. In some further embodiments, the concentration of the surfactant is about 0.80%. In some further embodiments, the concentration of the surfactant is about 0.85%. In some further embodiments, the concentration of the surfactant is about 0.90%. In some further embodiments, the concentration of the surfactant is about 0.95%. In some further embodiments, the concentration of the surfactant is about 1.0%. In some further embodiments, the concentration of the surfactant is about 1.25%. In some further embodiments, the concentration of the surfactant is about 1.5%. In some further embodiments, the concentration of the surfactant is about 1.75%. In some further embodiments, the concentration of the surfactant is about 2%. In some further embodiments, the concentration of the surfactant is about 3%. In some further embodiments, the concentration of the surfactant is about 4%. In some further embodiments, the concentration of the surfactant is about 5%.

In some embodiments, the concentration of the compound of Formula I is about 4%. In some further embodiments, the concentration of the surfactant is about 0.05%. In some further embodiments, the concentration of the surfactant is about 0.10%. In some further embodiments, the concentration of the surfactant is about 0.15%. In some further embodiments, the concentration of the surfactant is about 0.20%. In some further embodiments, the concentration of the surfactant is about 0.25%. In some further embodiments, the concentration of the surfactant is about 0.30%. In some further embodiments, the concentration of the surfactant is about 0.35%. In some further embodiments, the concentration of the surfactant is about 0.40%. In some further embodiments, the concentration of the surfactant is about 0.45%. In some further embodiments, the concentration of the surfactant is about 0.50%. In some further embodiments, the concentration of the surfactant is about 0.55%. In some further embodiments, the concentration of the surfactant is about 0.60%. In some further embodiments, the concentration of the surfactant is about 0.65%. In some further embodiments, the concentration of the surfactant is about 0.70%. In some further embodiments, the concentration of the surfactant is about 0.75%. In some further embodiments, the concentration of the surfactant is about 0.80%. In some further embodiments, the concentration of the surfactant is about 0.85%. In some further embodiments, the concentration of the surfactant is about 0.90%. In some further embodiments, the concentration of the surfactant is about 0.95%. In some further embodiments, the concentration of the surfactant is about 1.0%. In some further embodiments, the concentration of the surfactant is about 1.25%. In some further embodiments, the concentration of the surfactant is about 1.5%. In some further embodiments, the concentration of the surfactant is about 1.75%. In some further embodiments, the concentration of the surfactant is about 2%. In some further embodiments, the concentration of the surfactant is about 3%. In some further embodiments, the concentration of the surfactant is about 4%. In some further embodiments, the concentration of the surfactant is about 5%.

In some embodiments, the concentration of the compound of Formula I is about 5%. In some further embodiments, the concentration of the surfactant is about 0.05%. In some further embodiments, the concentration of the surfactant is about 0.10%. In some further embodiments, the concentration of the surfactant is about 0.15%. In some further embodiments, the concentration of the surfactant is about 0.20%. In some further embodiments, the concentration of the surfactant is about 0.25%. In some further embodiments, the concentration of the surfactant is about 0.30%. In some further embodiments, the concentration of the surfactant is about 0.35%. In some further embodiments, the concentration of the surfactant is about 0.40%. In some further embodiments, the concentration of the surfactant is about 0.45%. In some further embodiments, the concentration of the surfactant is about 0.50%. In some further embodiments, the concentration of the surfactant is about 0.55%. In some further embodiments, the concentration of the surfactant is about 0.60%. In some further embodiments, the concentration of the surfactant is about 0.65%. In some further embodiments, the concentration of the surfactant is about 0.70%. In some further embodiments, the concentration of the surfactant is about 0.75%. In some further embodiments, the concentration of the surfactant is about 0.80%. In some further embodiments, the concentration of the surfactant is about 0.85%. In some further embodiments, the concentration of the surfactant is about 0.90%. In some further embodiments, the concentration of the surfactant is about 0.95%. In some further embodiments, the concentration of the surfactant is about 1.0%. In some further embodiments, the concentration of the surfactant is about 1.25%. In some further embodiments, the concentration of the surfactant is about 1.5%. In some further embodiments, the concentration of the surfactant is about 1.75%. In some further embodiments, the concentration of the surfactant is about 2%. In some further embodiments, the concentration of the surfactant is about 3%. In some further embodiments, the concentration of the surfactant is about 4%. In some further embodiments, the concentration of the surfactant is about 5%.

In some embodiments, the aqueous compositions can further include a viscosity enhancing water-soluble polymer. In some embodiments, the water-soluble polymer may be a biopolymer such as xanthan gum or scleroglucan, a synthetic polymer such as polyacryamide, hydrolyzed polyarcrylamide or co-polymers of acrylamide and acrylic acid, 2-acrylamido 2-methyl propane sulfonate or N-vinyl pyrrolidone, a synthetic polymer such as polyethylene oxide, or any other high molecular weight polymer soluble in water or brine. In some embodiments, the polymer is polyacrylamide (PAM), partially hydrolyzed polyacrylamides (HPAM), and copolymers of 2-acrylamido-2-methylpropane sulfonic acid or sodium salt or mixtures thereof, and polyacrylamide (PAM) commonly referred to as AMPS copolymer and mixtures of the copolymers thereof. In one embodiment, the viscosity enhancing water-soluble polymer is polyacrylamide or a co-polymer of polyacrylamide. In one embodiment, the viscosity enhancing water-soluble polymer is a partially (e.g. 20%, 25%, 30%, 35%, 40%, 45%) hydrolyzed anionic polyacrylamide. In some further embodiment, the viscosity enhancing water-soluble polymer has a molecular weight of approximately about 8×10⁶ Daltons. In some other further embodiment, the viscosity enhancing water-soluble polymer has a molecular weight of approximately about 18×10⁶ Daltons. Non-limiting examples of commercially available polymers useful for the invention including embodiments provided herein are Florpaam 3330S and Florpaam 3360S. Molecular weights of the polymers may range from about 10,000 Daltons to about 20,000,000 Daltons. In some embodiments, the viscosity enhancing water-soluble polymer is used in the range of about 500 to about 5000 ppm concentration, such as from about 1000 to 2000 ppm (e.g., in order to match or exceed the reservoir oil viscosity under the reservoir conditions of temperature and pressure).

In some embodiments, the aqueous compositions can further include an alkali agent. An alkali agent as provided herein can be a basic, ionic salt of an alkali metal (e.g., lithium, sodium, potassium) or alkaline earth metal element (e.g., magnesium, calcium, barium, radium). Examples of suitable alkali agents include, for example, NaOH, KOH, LiOH, Na₂CO₃, NaHCO₃, Na-metaborate, Na silicate, Na orthosilicate, Na acetate or NH₄OH. The aqueous composition may include seawater, or fresh water from an aquifer, river or lake. In some embodiments, the aqueous composition includes hard brine water or soft brine water. In some further embodiments, the water is soft brine water. In some further embodiments, the water is hard brine water. Where the aqueous composition includes soft brine water, the aqueous composition can further include an alkaline agent. In soft brine water the alkaline agent can provide for enhanced soap generation from the active oils, lower surfactant adsorption to the solid material (e.g., rock) in the reservoir and increased solubility of viscosity enhancing water soluble polymers.

The alkali agent can be present in the aqueous composition at a concentration from about 0.1% w/w to about 10% w/w. The combined amount of alkali agent and compound provided herein (e.g., compound of Formula I) present in the aqueous composition provided herein can be approximately equal to or less than about 10% w/w. In some embodiments, the total concentration of alkali agent (i.e., the total amount of alkali agent within the aqueous compositions and emulsion compositions provided herein) in is from about 0.05% w/w to about 5% w/w. In other embodiments, the total alkali agent concentration in the aqueous composition is from about 0.25% w/w to about 5% w/w. In other embodiments, the total alkali agent concentration in the aqueous composition is about 0.5% w/w. In other embodiments, the total alkali agent concentration in the aqueous composition is about 0.75% w/w. In other embodiments, the total alkali agent concentration in the aqueous composition is about 1% w/w. In other embodiments, the total alkali agent concentration in the aqueous composition is about 1.25% w/w. In other embodiments, the total alkali agent concentration in the aqueous composition is about 1.50% w/w. In other embodiments, the total alkali agent concentration in the aqueous composition is about 1.75% w/w. In other embodiments, the total alkali agent concentration in the aqueous composition is about 2% w/w. In other embodiments, the total alkali agent concentration in the aqueous composition is about 2.25% w/w. In other embodiments, the total alkali agent concentration in the aqueous composition is about 2.5% w/w. In other embodiments, the total alkali agent concentration in the aqueous composition is about 2.75% w/w. In other embodiments, the total alkali agent concentration in the aqueous composition is about 3% w/w. In other embodiments, the total alkali agent concentration in the aqueous composition is about 3.25% w/w. In other embodiments, the total alkali agent concentration in the aqueous composition is about 3.5% w/w. In other embodiments, the total alkali agent concentration in the aqueous composition is about 3.75% w/w. In other embodiments, the total alkali agent concentration in the aqueous composition is about 4% w/w. In other embodiments, the total alkali agent concentration in the aqueous composition is about 4.25% w/w. In other embodiments, the total alkali agent concentration in the aqueous composition is about 4.5% w/w. In other embodiments, the total alkali agent concentration in the aqueous composition is about 4.75% w/w. In other embodiments, the total alkali agent concentration in the aqueous composition is about 5.0% w/w.

In some embodiments, the aqueous compositions can further include a co-solvent. In embodiments, the co-solvent is an alcohol, alcohol ethoxylate, glycol ether, glycols, or glycerol. The aqueous compositions provided herein may include more than one co-solvent. Thus, in embodiments, the aqueous composition includes a plurality of different co-solvents. Where the aqueous composition includes a plurality of different co-solvents, the different co-solvents can be distinguished by their chemical (structural) properties. For example, the aqueous composition may include a first co-solvent, a second co-solvent and a third co-solvent, wherein the first co-solvent is chemically different from the second and the third co-solvent, and the second co-solvent is chemically different from the third co-solvent. In embodiments, the plurality of different co-solvents includes at least two different alcohols (e.g., a C₁-C₆ alcohol and a C₁-C₄ alcohol). In embodiments, the aqueous composition includes a C₁-C₆ alcohol and a C₁-C₄ alcohol. In embodiments, the plurality of different co-solvents includes at least two different alkoxy alcohols (e.g., a C₁-C₆ alkoxy alcohol and a C₁-C₄ alkoxy alcohol). In embodiments, the aqueous composition includes a C₁-C₆ alkoxy alcohol and a C₁-C₄ alkoxy alcohol. In embodiments, the plurality of different co-solvents includes at least two co-solvents selected from the group consisting of alcohols, alkyl alkoxy alcohols and phenyl alkoxy alcohols. For example, the plurality of different co-solvents may include an alcohol and an alkyl alkoxy alcohol, an alcohol and a phenyl alkoxy alcohol, or an alcohol, an alkyl alkoxy alcohol and a phenyl alkoxy alcohol. The alkyl alkoxy alcohols or phenyl alkoxy alcohols provided herein have a hydrophobic portion (alkyl or aryl chain), a hydrophilic portion (e.g., an alcohol) and optionally an alkoxy (ethoxylate or propoxylate) portion. Thus, in embodiments, the co-solvent is an alcohol, alkoxy alcohol, glycol ether, glycol or glycerol. Suitable co-solvents are known in the art, and include, for example, surfactants described in U.S. Patent Application Publication No. 2013/0281327 which is hereby incorporated herein in its entirety.

In some embodiments, a co-solvent can be present in an amount sufficient to increase the solubility of the alkoxylated co-solvent and/or surfactant (when present) in the aqueous phase relative to the absence of the co-solvent. In other words, in the presence of a sufficient amount of the co-solvent, the solubility of the co-solvent in the aqueous phase is higher than in the absence of the co-solvent. In embodiments, the co-solvent can be present in an amount sufficient to increase the solubility of the surfactant in the aqueous phase relative to the absence of the co-solvent. Thus, in the presence of a sufficient amount of the co-solvent the solubility of the surfactant in the aqueous phase can be higher than in the absence of the co-solvent. In embodiments, the co-solvent can be present in an amount sufficient to decrease the viscosity of an emulsion formed from the composition relative to the absence of the co-solvent.

In other embodiments, the aqueous composition can be substantially free of co-solvents (e.g., the composition can include less than 0.05% by weight co-solvents, based on the total weight of the composition).

In some embodiments, the aqueous composition can further include a gas. For instance, the gas may be combined with the aqueous composition to reduce its mobility by decreasing the liquid flow in the pores of the solid material (e.g., rock). In some embodiments, the gas may be supercritical carbon dioxide, nitrogen, natural gas or mixtures of these and other gases.

In some embodiments, the aqueous composition can have a pH of at least 7 (e.g., a pH of at least 7.5, a pH of at least 8, a pH of at least 8.5, a pH of at least 9, a pH of at least 9.5, a pH of at least 10, a pH of at least 10.5, a pH of at least 11, a pH of at least 11.5, or a pH of at least 12.5). In some embodiments, the aqueous composition can have a pH of 13 or less (e.g., a pH of 12.5 or less, a pH of 12 or less, a pH of 11.5 or less, a pH of 11 or less, a pH of 10.5 or less, a pH of 10 or less, a pH of 9.5 or less, a pH of 9 or less, a pH of 8.5 or less, a pH of 8 or less, or a pH of 7.5 or less).

The aqueous composition can have a pH ranging from any of the minimum values described above to any of the maximum values described above. For example, the aqueous composition can have a pH of from 7 to 13 (e.g., from 10 to 12, or from 10.5 to 11.5).

In some embodiments, the aqueous composition can have a salinity of at least 5,000 ppm. In other embodiments, the aqueous composition has a salinity of at least 50,000 ppm. In other embodiments, the aqueous composition has a salinity of at least 100,000 ppm. In other embodiments, the aqueous composition has a salinity of at least 250,000 ppm. The total range of salinity (total dissolved solids in the brine) is 100 ppm to saturated brine (about 260,000 ppm). The aqueous composition may include seawater, brine or fresh water from an aquifer, river or lake. The aqueous combination may further include salt to increase the salinity. In some embodiments, the salt is NaCl, KCl, CaCl₂, MgCl₂, CaSO₄, Na acetate or Na₂CO₃.

In some embodiments, the aqueous composition can have a temperature of at least 20° C. (e.g., at least 30° C., at least 40° C., at least 50° C., at least 60° C., at least 70° C., at least 80° C., at least 90° C., at least 100° C., or at least 110° C.). The aqueous composition can have a temperature of 120° C. or less (e.g., 110° C. or less, 100° C. or less, 90° C. or less, 80° C. or less, 70° C. or less, 60° C. or less, 50° C. or less, 40° C. or less, or 30° C. or less).

The aqueous composition can have a temperature ranging from any of the minimum values described above to any of the maximum values described above. For example, the aqueous composition can have a temperature of from 20° C. to 120° C. (e.g., from 50° C. to 120° C., or from 80° C. to 120° C.).

In some embodiments, the aqueous composition can have a viscosity of between 20 mPas and 100 mPas at 20° C. The viscosity of the aqueous solution may be increased from 0.3 mPas to 1, 2, 10, 20, 100 or even 1000 mPas by including a water-soluble polymer. As mentioned above, the apparent viscosity of the aqueous composition may be increased with a gas (e.g., a foam forming gas) as an alternative to the water-soluble polymer.

Also provided are emulsions comprising compositions described herein or the compounds described herein and unrefined petroleum. In some embodiments, the emulsion composition can be a microemulsion. A “microemulsion” as referred to herein is a thermodynamically stable mixture of oil, water and surfactants that may also include additional components such as additional co-solvents, electrolytes, alkali and polymers. In contrast, a “macroemulsion” as referred to herein is a thermodynamically unstable mixture of oil and water that may also include additional components. The emulsion composition provided herein may be an oil-in-water emulsion, wherein a surfactant forms aggregates (e.g., micelles) where the hydrophilic part of the surfactant molecule(s) contacts the aqueous phase of the emulsion and the lipophilic part contacts the oil phase of the emulsion. Thus, in some embodiments, the surfactant(s) form part of the aqueous part of the emulsion. And in other embodiments, the surfactant(s) form part of the oil phase of the emulsion. In yet another embodiment, the surfactant(s) form part of an interface between the aqueous phase and the oil phase of the emulsion.

In some embodiments, the unrefined patroleum can include live oil. In some embodiments, the live oil can have a gas/oil ratio (GOR) of from 100 to 10,000 scf/bbl, such as from 200 to 10,000 scf/bbl, from 500 to 5,000 scf/bbl, from 500 to 1,500 scf/bbl, from 1,000 to 6,000 scf/bbl, or from 1,000 to 5,000 scf/bbl.

### Methods

In another aspect, a method of displacing a hydrocarbon material in contact with a solid material is provided. The method includes contacting a hydrocarbon material with a compound as described herein or the composition described herein, wherein the hydrocarbon material is in contact with a solid material. The hydrocarbon material is allowed to separate from the solid material thereby displacing the hydrocarbon material in contact with the solid material.

In some embodiments, the method can be a method for recovering hydrocarbons from a subterranean formation. The method including a) introducing the compound described herein or the composition described herein through a wellbore into the subterranean formation; and b) producing fluids from the subterranean formation; wherein the hydrocarbons in the subterranean formation comprise live oil. In some embodiments, step (a) comprises injecting the compound described herein or the composition described herein through an injection wellbore into the subterranean formation. In some embodiments, step (b) comprises producing the fluids from a production wellbore spaced apart from the injection wellbore a predetermined distance and in fluid communication with the subterranean formation. In some embodiments, the injection of the compound described herein or the composition described herein increases a flow of hydrocarbons to the production wellbore.

In some embodiments, the unrefined patroleum comprises live oil. In some embodiments, the live oil has a gas/oil ratio (GOR) of from 100 to 10,000 scf/bbl, such as from 200 to 10,000 scf/bbl, from 500 to 5,000 scf/bbl, from 500 to 1,500 scf/bbl, from 1,000 to 6,000 scf/bbl, or from 1,000 to 5,000 scf/bbl.

In other embodiments, the hydrocarbon material is unrefined petroleum (e.g., in a petroleum reservoir). In some further embodiments, the unrefined petroleum is an unrefined petroleum with an API gravity greater than 30. In some embodiments, the API gravity of the unrefined petroleum is greater than 30. In other embodiments, the API gravity of the unrefined petroleum is greater than 40. In some embodiments, the API gravity of the unrefined petroleum is greater than 50. In other embodiments, the API gravity of the unrefined petroleum is greater than 60. In some embodiments, the API gravity of the unrefined petroleum is greater than 70. In other embodiments, the API gravity of the unrefined petroleum is greater than 80. In some embodiments, the API gravity of the unrefined petroleum is greater than 90. In other embodiments, the API gravity of the unrefined petroleum is greater than 100. In some other embodiments, the API gravity of the unrefined petroleum is between 30 and 100.

The solid material may be a natural solid material (i.e., a solid found in nature such as rock). The natural solid material may be found in a petroleum reservoir. In some embodiments, the method is an enhanced oil recovery method. Enhanced oil recovery methods are well known in the art. A general treatise on enhanced oil recovery methods is Basic Concepts in Enhanced Oil Recovery Processes edited by M. Baviere (published for SCI by Elsevier Applied Science, London and New York, 1991). For example, in an enhanced oil recovery method, the displacing of the unrefined petroleum in contact with the solid material is accomplished by contacting the unrefined with a compound provided herein, wherein the unrefined petroleum is in contact with the solid material. The unrefined petroleum may be in an oil reservoir. The compound or composition provided herein can be pumped into the reservoir in accordance with known enhanced oil recovery parameters. The compound can be pumped into the reservoir as part of the aqueous compositions provided herein and, upon contacting the unrefined petroleum, form an emulsion composition provided herein.

In some embodiments, the natural solid material can be rock or regolith. The natural solid material can be a geological formation such as elastics or carbonates. The natural solid material can be either consolidated or unconsolidated material or mixtures thereof. The hydrocarbon material may be trapped or confined by “bedrock” above or below the natural solid material. The hydrocarbon material may be found in fractured bedrock or porous natural solid material. In other embodiments, the regolith is soil.

In some embodiments, an emulsion forms after the contacting step. The emulsion thus formed can be the emulsion described above. In some embodiments, the emulsion thus formed can be a microemulsion. In some embodiments, the method includes allowing an unrefined petroleum acid within the unrefined petroleum material to enter into the emulsion, thereby converting the unrefined petroleum acid into a surfactant. In other words, where the unrefined petroleum acid converts into a surfactant it is mobilized and therefore separates from the solid material.

In another aspect, a method of converting (e.g., mobilizing) an unrefined petroleum acid into a surfactant is provided. The method includes contacting a petroleum material with an aqueous composition thereby forming an emulsion in contact with the petroleum material, wherein the aqueous composition includes the compound described herein. Thus, in some embodiments, the aqueous composition is the aqueous composition described above. An unrefined petroleum acid within the unrefined petroleum material is allowed to enter into the emulsion, thereby converting the unrefined petroleum acid into a surfactant.

In some embodiments, the reactive petroleum material is in a petroleum reservoir. In some embodiments, as described above and as is generally known in the art, the unrefined petroleum acid is a naphthenic acid. In some embodiments, as described above and as is generally known in the art, the unrefined petroleum acid is a mixture of naphthenic acid. In some embodiments, the aqueous composition further includes an alkali agent.

In these embodiments, the composition can comprise a compound described herein, an alkali agent, an additional surfactant, a co-solvent, and a polymer. Methods can comprise injecting a composition of this type into a hydrocarbon reservoir comprising unrefined petroleum material in contact with the solid material. In certain embodiments, the unrefined petroleum material can comprise an active oil. In these embodiments, the composition can have a pH effective to convert unrefined petroleum acid present in the unrefined petroleum material into a surfactant.

In these embodiments, the composition can comprise a compound described herein, an alkali agent, co-solvent, and a polymer. Methods can comprise injecting a composition of this type into a hydrocarbon reservoir comprising unrefined petroleum material in contact with the solid material. In certain embodiments, the unrefined petroleum material can comprise an active oil. In these embodiments, the composition can have a pH effective to convert unrefined petroleum acid present in the unrefined petroleum material into a surfactant.

In these embodiments, the composition can comprise a compound described herein, a co-solvent, and a polymer. Methods can comprise injecting a composition of this type into a hydrocarbon reservoir comprising unrefined petroleum material in contact with the solid material.

In these embodiments, the composition can comprise a compound described herein. Methods can comprise injecting a composition of this type into a hydrocarbon reservoir comprising unrefined petroleum material in contact with the solid material. In certain embodiments, the unrefined petroleum material can comprise an active oil. In these embodiments, the composition can have a pH effective to convert unrefined petroleum acid present in the unrefined petroleum material into a surfactant.

In another aspect, a method of making a compound as described herein is provided. The methods can include contacting a suitable alcohol precursor for the co-solvent with a propylene oxide thereby forming an alkoxylate hydrophobe.

In certain aspects, the compounds described herein can be used in Chemical Enhanced Oil Recovery (CEOR), for example, for:
1. Improving hydrophilicity/hydrophilicity balance of alkali-polymer (AP) flood
2. Acting as cosolvent/cosurfactant in alkali-co-solvent-polymer (ACP) and/or alkali-surfactant-polymer (ASP) floods
3. Providing a low IFT, “improved polymer flood” environment in the event that surfactant, etc. adsorbs.

In certain aspects, the compounds described herein can be used in CO₂ Processes, for example, for:
1. Potential for CO₂ wettability alteration due to amine going to water/CO₂ interface
2. Potential for improved CO₂ storage due to changing residual CO₂ saturation and wettability

In certain aspects, the compounds described herein should show affinity towards CO₂, especially supercritical CO₂. This should lead to improved CO₂ storage via surface wettability alteration and/or residual phase trapping, among other benefits.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

What is claimed is:

1. A compound defined by Formula I 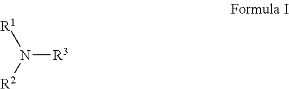
wherein
R³ is a C₁-C₆ alkyl or C₃-C₆ cycloalkyl, 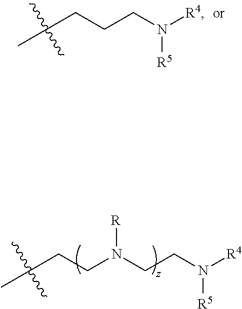
R, R¹, R², R⁴, and R⁵ are, independently for each occurrence, hydrogen, C₁-C₆ alkyl or C₃-C₆ cycloalkyl, —(PO)ₓ, or —(PO)ₓ(EO)_{y}, wherein at least one of R¹, R², R⁴, R⁵, or R is —(PO)ₓH, or —(PO)ₓ(EO)_{y}H;
x is an integer from 1 to 10;
y is an integer from 0-30; and
z is an integer from 0 to 10.

2. The compound of claim 1, wherein R¹ and R² are —(PO)ₓH.

3. The compound of one of claims 1-2, wherein R³ is C₁-C₆ alkyl or C₃-C₆ cycloalkyl.

4. The compound of claim 1, wherein R³ is

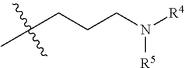

5. The compound of claim 1 or claim 4, wherein R¹ and R² are C₁-C₆ alkyl.

6. The compound of any one of claims 1 or 4-5, wherein R⁴ and R⁵ are —(PO)ₓH.

7. The compound of any one of claims 1 or 4-6, wherein x is 2.

8. The compound of any one of claims 1 or 4, wherein R¹ and R⁴ are C₁-C₆ alkyl.

9. The compound of any one of claims 1, 4, or 8, wherein R² and R⁵ are —(PO)ₓH.

10. The compound of any one of claims 1-2, wherein R³ is

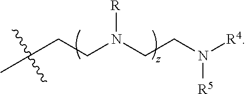

11. The compound of any one of claims 1 or 10, wherein z is 0.

12. The compound of any one of claims 1 or 10, wherein z is 1.

13. The compound of any one of claims 1 or 10, wherein z is 2.

14. The compound of any one of claims 1 or 10-13, wherein at least one of R¹, R², R⁴, R⁵, or R is —(PO)ₓH.

15. The compound of any one of claims 1, 10, or 13-14, wherein R⁴, R⁵, and R are —(PO)ₓH.

16. The compound of any one of claims 1 or 10-11, wherein R⁴ and R⁵ are —(PO)ₓH.

17. The compound of any one of claims 1 or 10-13, wherein at least one of R¹, R², R⁴, R⁵, or R is —(PO)ₓ(EO)_{y}H.

18. The compound of any one of claims 1, 10, or 13-14, wherein R⁴, R⁵, and R are —(PO)ₓ(EO)_{y}H.

19. The compound of any one of claims 1 or 10-11, wherein R⁴ and R⁵ are —(PO)ₓ(EO)_{y}H.

20. The compound of any one of claims 1-2, or 10-19, wherein R³ is

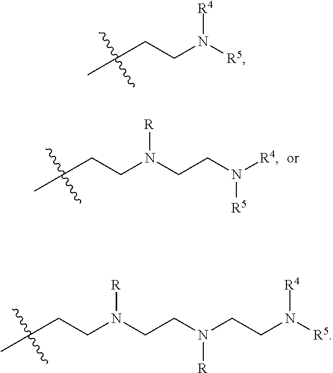

21. The compound of any one of claims 1-20, wherein the compound is selected from:

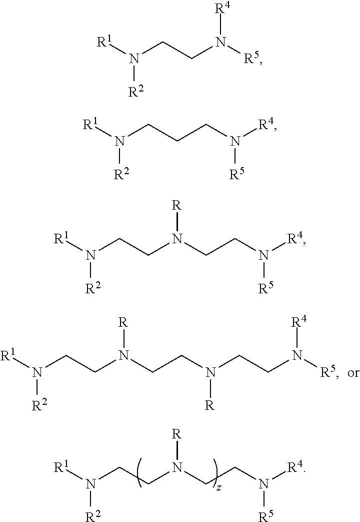

22. The compound of any one of claims 1 to 20, wherein the compound is selected from:

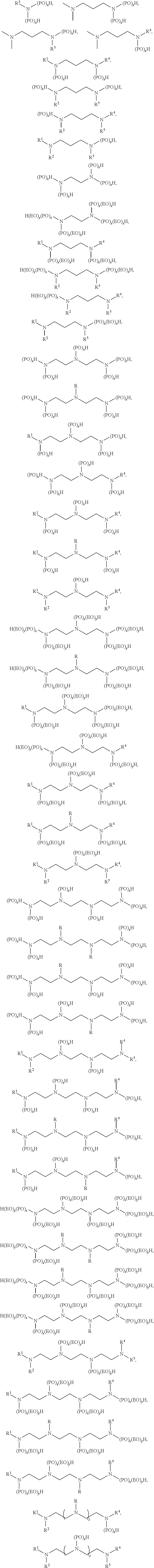

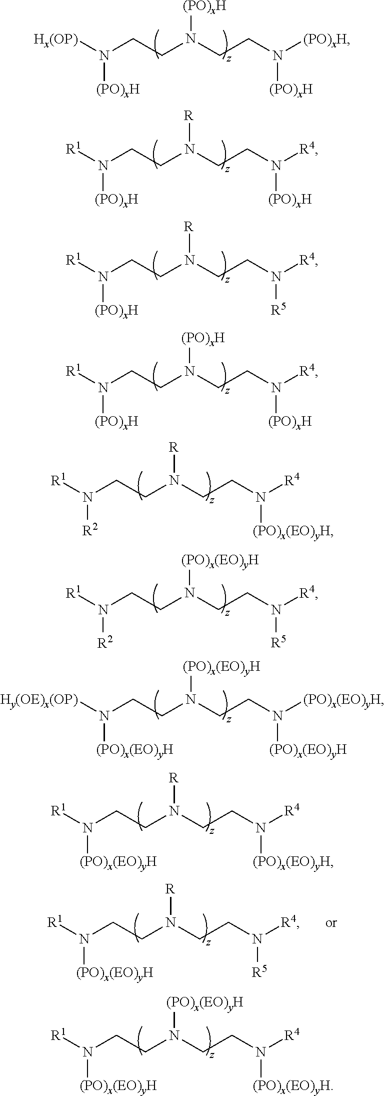

23. An aqueous composition comprising water and the compound of any of claims 1-22.

24. The composition of claim 23, wherein the compound of any of claims 1-19 is present in the composition in an amount of from 0.1% to 2% by weight, based on the total weight of the composition.

25. The composition of any of claims 23-24, wherein the composition further comprises one or more additional surfactants.

26. The composition of claim 25, wherein the one or more additional surfactants comprise an anionic surfactant, a cationic surfactant, a non-ionic surfactant, a zwitterionic surfactant, or any combination thereof.

27. The composition of any claims 23-26, wherein the one or more additional surfactants are present in the composition in an amount of from 0.05% to 5% by weight, based on the total weight of the composition.

28. The composition of any of claims 23-27, wherein the composition further comprises a viscosity-enhancing water-soluble polymer.

29. The composition of any of claims 23-28, wherein the composition further comprises an alkali agent.

30. The composition of claim 29, wherein the composition has a pH of from 10 to 12.

31. The composition of any of claims 23-30, wherein the composition further comprises one or more co-solvents.

32. The composition of any of claims 23-31, wherein the composition has a salinity of at least 5,000 ppm.

33. An emulsion comprising the composition of any of claims 23-32 or the compound of any one of claims 1-22 and (ii) unrefined petroleum.

34. The emulsion of claim 33, wherein the unrefined patroleum comprises live oil.

35. The emulsion of claim 34, wherein the live oil has a gas/oil ratio (GOR) of from 10 to 10,000 scf/bbl, such as from 100 to 10,000 scf/bbl, from 200 to 10,000 scf/bbl, from 500 to 5,000 scf/bbl, from 500 to 1,500 scf/bbl, from 1,000 to 6,000 scf/bbl, or from 1,000 to 5,000 scf/bbl.

36. A method of displacing an unrefined petroleum material in contact with a solid material, said method comprising:
(i) contacting the unrefined petroleum material with the compound of any one of claims 1-22 or the composition of any of claims 23-32, wherein the unrefined petroleum material is in contact with the solid material; and
(ii) allowing the unrefined petroleum material to separate from the solid material, thereby displacing the unrefined petroleum material in contact with the solid material.

37. The method of claim 36, wherein the unrefined patroleum comprises live oil.

38. The method of claim 37, wherein the live oil has a gas/oil ratio (GOR) of from 10 to 10,000 scf/bbl, such as from 100 to 10,000 scf/bbl, from 200 to 10,000 scf/bbl, from 500 to 5,000 scf/bbl, from 500 to 1,500 scf/bbl, from 1,000 to 6,000 scf/bbl, or from 1,000 to 5,000 scf/bbl.

39. A method for recovering hydrocarbons from a subterranean formation, the method comprising
(a) introducing the compound of any of claims 1-22 or the composition of any of claims 23-32 through a wellbore into the subterranean formation; and
(b) producing fluids from the subterranean formation;
wherein the hydrocarbons in the subterranean formation comprise live oil.

40. The method of claim 39, wherein step (a) comprises injecting the compound of any of claims 1-22 or the composition of any of claims 23-32 through an injection wellbore into the subterranean formation.

41. The method of claim 39, wherein step (b) comprises producing the fluids from a production wellbore spaced apart from the injection wellbore a predetermined distance and in fluid communication with the subterranean formation;
wherein injection of the compound of any of claims 1-22 or the composition of any of claims 23-32 increases a flow of hydrocarbons to the production wellbore.

42. The method of any of claims 39-41, wherein the live oil has a gas/oil ratio (GOR) of from 10 to 10,000 scf/bbl, such as from 100 to 10,000 scf/bbl, from 200 to 10,000 scf/bbl, from 500 to 5,000 scf/bbl, from 500 to 1,500 scf/bbl, from 1,000 to 6,000 scf/bbl, or from 1,000 to 5,000 scf/bbl.

43. The use of the compound of any of claims 1-22 in CO₂ storage or sequestration, or as a CO₂ absorber.
